(19) United States
(12) Patent Application Publication
(10) Pub. No.: US 2023/0344815 A1
(43) Pub. Date: Oct. 26, 2023

(54) END-POINT INSTANCE INDEXING AND OWNER POP SELECTION IN GATEWAY SERVICE TICKETING

(71) Applicant: Citrix Systems, Inc., Fort Lauderdale, FL (US)

(72) Inventor: Santosh Kumar Swain, Bangalore (IN)

(21) Appl. No.: 17/729,564

(22) Filed: Apr. 26, 2022

(51) Int. Cl. H04L 9/40; H04L 67/141

(52) U.S. Cl. CPC H04L 63/0807; H04L 67/141

(57) ABSTRACT

Systems and methods for indexing to an end-point instance and selecting an owner point of presence (POP) are provided. A system can include one or more processors coupled to memory. The system can receive a request to process a ticket used to authenticate a connection to a session between a client device and one or more servers. The system can locate a plurality of access points across a plurality of groups of access points that each maintain the ticket in storage on the plurality of access points based on a function applied to an identifier of the ticket. The system can provide the request to at least one access point of the plurality of access points located based on the function to perform the process on the ticket.

### FIELD OF THE DISCLOSURE

This application generally relates to end-point instance indexing and owner point of presence (POP) selection in gateway service ticketing.

### BACKGROUND

A client device can communicate with a point of presence (POP) to access a network. The client device can communicate with a server on the network to establish a session. For example, the server can host an application and the client device can access or use the application during the session.

### SUMMARY

In a virtualized environment, a host system (e.g., a server or a machine, such as a single or multi-session machine) can host one or more sessions for individual users (e.g., client devices). Before a session can be established for a client device, the client device can be authenticated using one or more techniques. In some cases, a server that receives a request to establish a session can authenticate the request or the client device making the request. In some cases, such as in a secure network deployment, the request can be authenticated using a ticket. A server can defer or offload authentication to a ticketing service or instance, which can obtain a ticket associated with the request or client device and authenticate the request, client device, or user based on the ticket.

To establish a session, a client device can send a request to a point of presence (POP) (e.g., access point, demarcation point, appliance, node, etc.) hosting a ticketing instance (e.g., service instance or ticketing service instance). The client device can receive a ticket generated by the ticketing instance. The client device can send a ticket request to the POP for processing (e.g., updating the ticket, removing the ticket, such as when disconnecting from a session established with a server, authenticating the ticket, etc.). The POP selected to process the ticket can be based on the geographical location of the POP and the client device. The ticket for client devices may be stored on a particular POP, data center, entity, or appliance.

However, when the POP of a cloud provider or the cloud provider storing tickets for client devices is disconnected, goes down, or becomes unavailable, these tickets and the properties associated with the tickets may be temporarily or permanently inaccessible, lost, removed, or deleted. Further, storing the tickets in a certain POP or a cloud provider may overload the particular POP or cloud provider. As such, storing the ticket in one POP or cloud provider can be prone to data loss, thereby reducing resiliency of ticket availability, high resource consumption to regenerate the tickets, and extended downtime due to the re-authentication process, reestablishing a session for the client device, etc. Hence, this technical solution can enhance the resiliency of ticket availability and minimize the traffic or load to a particular POP or cloud provider.

The systems and methods of this technical solution can index client devices to multiple end-point instances and select owner POPs for establishing a session with a respective client device. A ticketing service instance (e.g., ticketing instance or service instance) can be deployed in a POP (e.g., each POP hosts a ticketing instance). Subsequent to receiving a request to establish a session from a client device, for instance, the ticketing instance of the POP can generate a ticket based on information from the client device, such as IP address (e.g., source or destination address), requested application or resource, packet header, among others. The ticket can be represented by an identifier, e.g., including at least one of numbers, characters, symbols, etc., unique for individual client devices. The ticketing instance can assign the ticket to multiple owner instances based on a configuration (e.g., rules, policies, etc.) applied to the ticket or information from the client device. Accordingly, the ticketing instance can distribute the ticket to the owner instances or owner POPs (e.g., the ticketing instance can be an owner instance) for storing a local copy of the generated ticket.

The owner instance can store a copy of the ticket in the local storage. The non-owner instance may not store a copy of the ticket, thereby relying on one of the owner instances to process the ticket from the ticket request. The ticketing instances (e.g., owner instance and non-owner instance) can serve the ticket request from the client device. For example, if the ticketing instance is the owner instance for the ticket being served, the ticketing instance can serve the request (e.g., process the ticket) from its local storage, such as comparing ticket properties or information for authorization, update the ticket, etc. Otherwise, if it is not the owner instance, the ticketing instance can broadcast or provide the ticket (e.g., included in the ticket request) to one or more owner instances. Once at least one owner instance obtains the ticket, this owner instance can respond to the ticketing instance (e.g., indicating the owner instance received the ticket) and serve the request for the client device (e.g., authorize the ticket, update the ticket, add the ticket, remove the ticket, among other ticket processing procedures). The ticketing instances can determine the ownership of the ticket based on a predetermined configuration, rule, or policy (e.g., similar configuration as when the ticket is added, updated, etc.). These ticketing instances may not be individual endpoints, rather the instances can be hosted under a common global uniform resource locator (URL). For instance, the ticketing instances can be aggregated and hosted under one URL accessible to one or more client devices.

In addition to serving the ticket request, the owner instance (or owner POP) can broadcast the ticket operation to other owners, thereby updating or reflecting the ticket operation (e.g., state of the ticket) to other POPs. The ticket operation can indicate whether the ticket is being served or whether a session associated with the ticket is established or active, for example. In some cases, the owner instance may broadcast to all POPs (e.g., owner and non-owner POPs) to update the ticket operation associated with the ticket request.

The configuration used to determine the owner instances or POPs can account for the different POP properties, such as geographical location, cloud providers, etc. The systems and methods can add, delete, or update the tickets or determine the owner of individual tickets using or according to the configuration. By selecting multiple POPs (or instances) or cloud providers as owners instead of having one or all POPs (or instances) as the owners for processing the ticket, the systems and methods can enhance the resiliency for ticket availability, while avoiding overloading of ticket requests to a particular POP or cloud provider. For instance, during an outage or unavailability of certain POPs, among other scenarios, another owner can maintain a copy of the ticket for processing additional incoming requests from client devices. Thus, the systems and methods described herein can enhance the resiliency of ticket availability, reduce resource consumption from regenerating tickets, and minimize the impact on tickets availability and POPs availability when adding or deleting POPs.

An aspect of this technical solution can be directed to a method for end-point instance indexing and owner POP selection. The method can include receiving, by one or more processors coupled to memory, a request to process a ticket used to authenticate a connection to a session between a client device and one or more servers. The method can include locating, by the one or more processors based on a function applied to an identifier of the ticket, a plurality of access points across a plurality of groups of access points that each maintain the ticket in storage on the plurality of access points. The method can include providing, by the one or more processors, the request to at least one access point of the plurality of access points located based on the function to perform the process on the ticket.

The method can include receiving, by the one or more processors, a response from the at least one access point indicating whether the client device is authorized for the connection to the session. The method can include transmitting, by the one or more processors, the response to the client device.

The method can include receiving, by the one or more processors, the request to process the ticket. The method can include determining, by the one or more processors, subsequent to processing the ticket, the one or more servers to host the session of an application for the client device based on the processed ticket. The method can include establishing, by the one or more processors, the connection to the session of an application hosted by the one or more servers.

A first access point of the plurality of access points can receive the request. The method can include determining, by the one or more processors, that the first access point is an owner access point for the ticket. The method can include providing, by the one or more processors, an update to one or more remaining owner access points indicating the first access point processing the request.

The method can include obtaining, by the one or more processors, the function comprising at least a binding rule and a destination selection rule. The binding rule can include one or more properties for assigning the plurality of access points to the plurality of groups. The destination selection rule can indicate one or more owner access points of the plurality of access points assigned to the ticket.

The method can include identifying, by the one or more processors, the plurality of groups in an n-ary structure, each of the plurality of groups comprising at least one of the plurality of access points. The method can include identifying, by the one or more processors, a plurality of cloud services associated with the plurality of groups. The method can include establishing, by the one or more processors, responsive to processing the ticket for authentication, the connection to the session hosted by the one or more servers of a cloud service associated with the at least one access point of at least one of the plurality of groups.

The method can include receiving, by the one or more processors, a request to add an access point. The method can include determining, by the one or more processors based on the function associated with one or more of the plurality of groups, a group of the plurality of groups to add the access point, the group comprising a first list comprising a plurality of indexes, each index associated with a respective access point. The method can include determining, by the one or more processors, a first timestamp associated with the request to add the access point. The method can include generating, by the one or more processors, a second list for the group comprising the plurality of indexes and a new index of the access point, the second list associated with the first timestamp.

The method can include receiving, by the one or more processors, the request to process the ticket. The method can include determining, by the one or more processors based on the function applied to the identifier of the ticket, the group assigned to the ticket. The method can include comparing, by the one or more processors, a second timestamp associated with when the ticket is created to the first timestamp. The method can include determining, by the one or more processors responsive to the comparison, to use the first list based on the second timestamp earlier than the first timestamp or use the second list based on the second timestamp at or later than the first timestamp.

The method can include determining, by the one or more processors responsive to generating the second list, an expiration of the first list based on a duration from the first timestamp satisfying a threshold. The method can include removing, by the one or more processors, the first list responsive to determining the expiration.

The method can include receiving, by the one or more processors, a request to delete an access point. The method can include determining, by the one or more processors based on the function associated with one or more of the plurality of groups, a group of the plurality of groups to delete the access point. The group can include a list comprising one or more indexes, each index associated with a respective access point. The method can include deleting, by the one or more processors based on the function, the index associated with the access point from the group.

The method can include determining, by the one or more processors, that the list of the group comprises one index associated with the access point. The method can include deleting, by the one or more processors based on the determination, the group from the plurality of groups.

An aspect of this technical solution can be directed to a system for end-point instance indexing and owner POP selection. The system can include one or more processors, coupled to memory. The one or more processors can be configured to receive a request to process a ticket used to authenticate a connection to a session between a client device and one or more servers. The one or more processors can be configured to locate, based on a function applied to an identifier of the ticket, a plurality of access points across a plurality of groups of access points that each maintain the ticket in storage on the plurality of access points. The one or more processors can be configured to provide the request to at least one access point of the plurality of access points to perform the process on the ticket.

The one or more processors can be configured to receive a response from the at least one access point indicating whether the client device is authorized for the connection to the session. The one or more processors can be configured to transmit the response to the client device.

The one or more processors can be configured to receive the request to process the ticket. The one or more processors can be configured to determine, subsequent to processing the ticket, the one or more servers to host the session of an application for the client device based on the processed ticket. The one or more processors can be configured to establish the connection to the session of an application hosted by the one or more servers.

A first access point of the plurality of access points can receive the request. The one or more processors can be configured to determine that the first access point is an owner access point for the ticket. The one or more processors can be configured to provide an update to one or more remaining owner access points indicating the first access point processing the request.

The one or more processors can be configured to obtain the function comprising at least a binding rule and a destination selection rule. The binding rule can include one or more properties for assigning the plurality of access points to the plurality of groups, the destination selection rule indicating one or more owner access points of the plurality of access points assigned to the ticket. The one or more processors can be configured to identify the plurality of groups in an n-ary structure, each of the plurality of groups comprising at least one of the plurality of access points.

The one or more processors can be configured to identify a plurality of cloud services associated with the plurality of groups. The one or more processors can be configured to establish, responsive to processing the ticket for authentication, the connection to the session hosted by the one or more servers of a cloud service associated with the at least one access point of at least one of the plurality of groups.

An aspect of this technical solution can be directed to a non-transitory computer readable storage medium storing instructions. The instructions, when executed by one or more processors, can cause the one or more processors to receive a request to process a ticket used to authenticate a connection to a session between a client device and one or more servers. The instructions, when executed by one or more processors, can cause the one or more processors to locate, based on a function applied to an identifier of the ticket, a plurality of access points across a plurality of groups that each maintain the ticket in storage on the plurality of access points. The instructions, when executed by one or more processors, can cause the one or more processors to provide the request to at least one access point of the plurality of access points to perform the process on the ticket.

These and other aspects and implementations are discussed in detail below. The foregoing information and the following detailed description include illustrative examples of various aspects and implementations, and provide an overview or framework for understanding the nature and character of the claimed aspects and implementations. This Summary is not intended to identify key features or essential features, nor is it intended to limit the scope of the claims included herewith. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of an example system for end-point instance indexing and owner POP selection, in accordance with one or more implementations;

FIG. 4 is an example diagram of POP placement with one level binding rule, in accordance with one or more implementations;

FIG. 5 is an example diagram of POP placement with two-level binding rule, in accordance with one or more implementations;

FIG. 6 is an example flow diagram for adding a POP, in accordance with one or more implementations;

FIG. 7 is an example flow diagram for deleting a POP, in accordance with one or more implementations; and

FIG. 8 is an example flow diagram of a method for end-point instance indexing and owner POP selection, in accordance with one or more implementations.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds; and

Section C describes systems and methods for end-point instance indexing and owner POP selection.

### A. Computing Environment

Prior to discussing the specifics of embodiments of the systems and methods of an appliance and/or client, it may be helpful to discuss the computing environments in which such embodiments may be deployed.

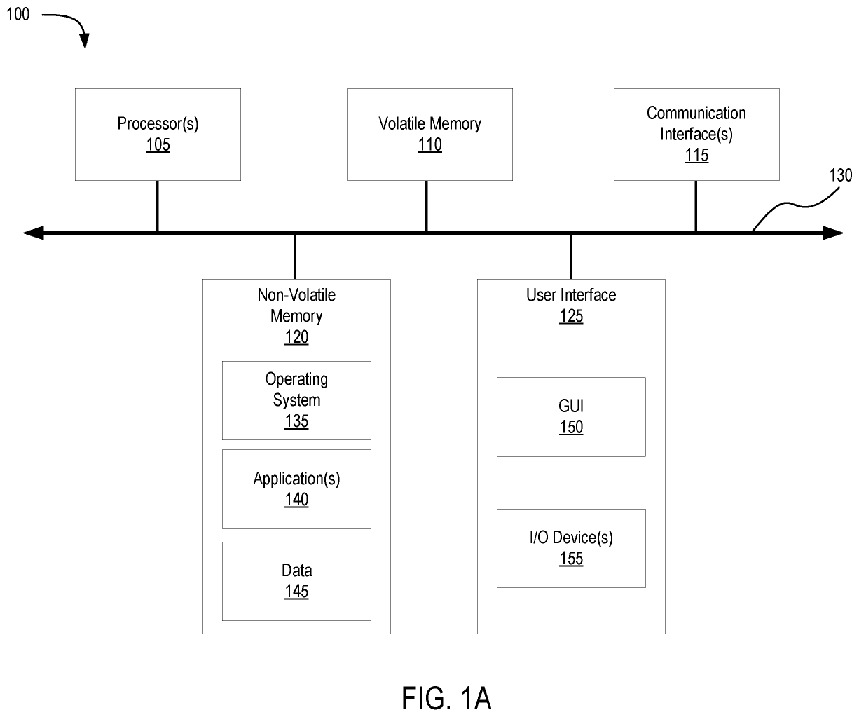

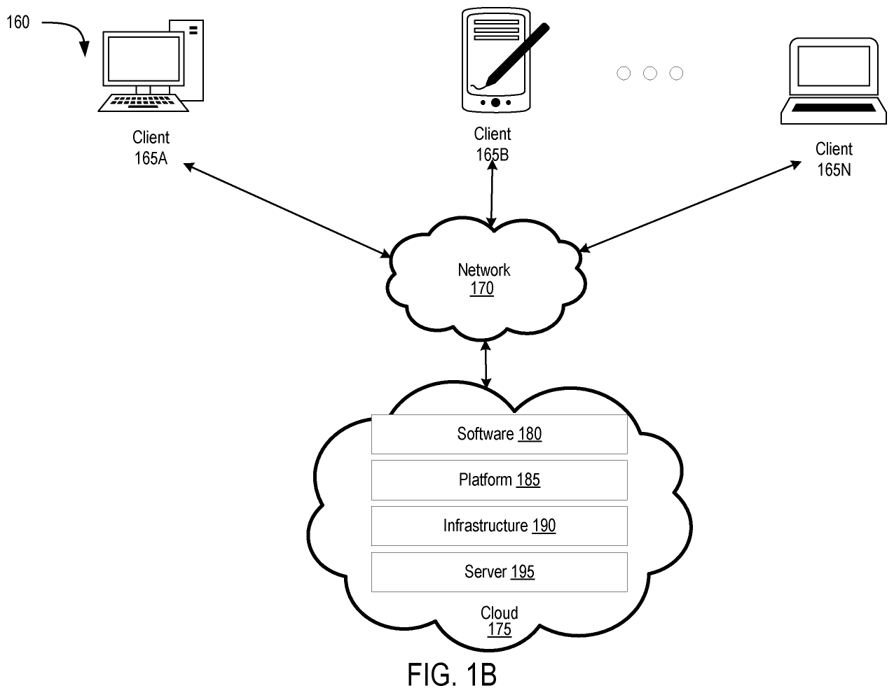

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 175 may include back-end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 175 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms or data centers. For example, the cloud 175 can include or correspond to a server (e.g., server 195) or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

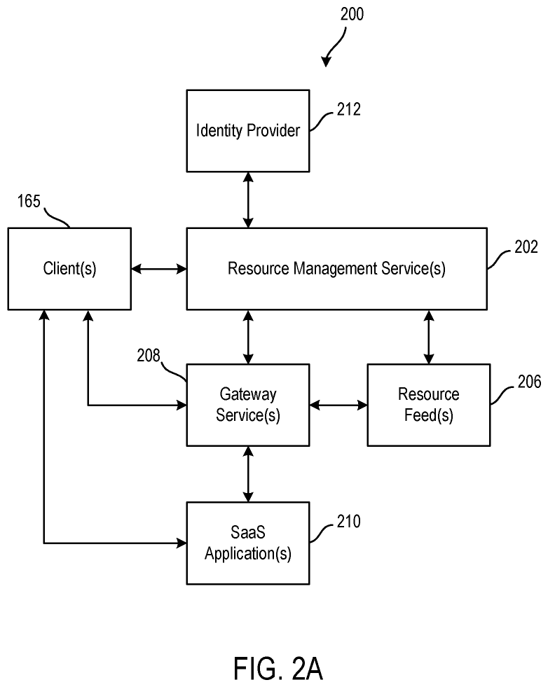

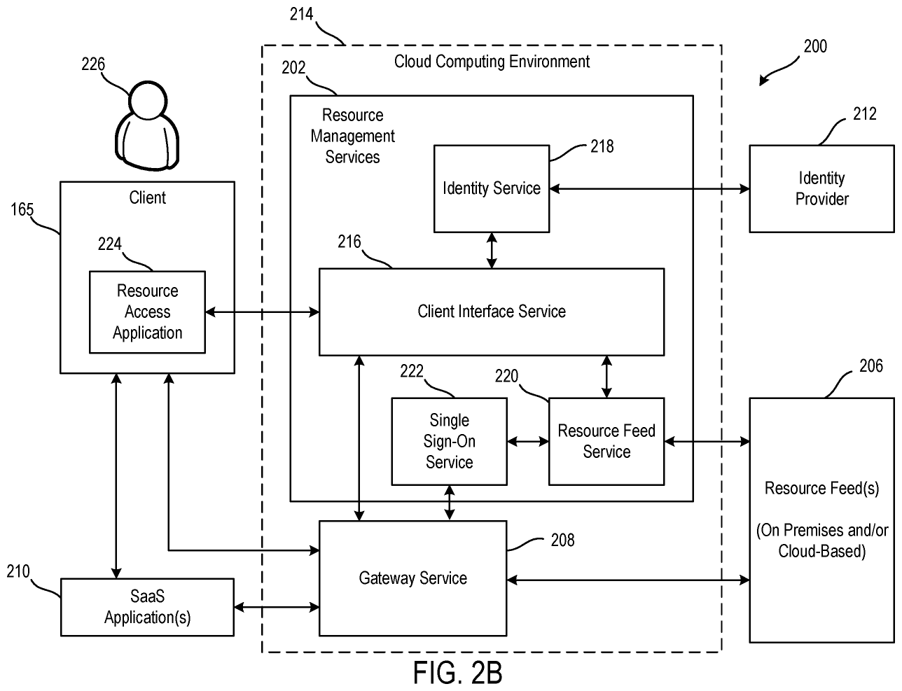

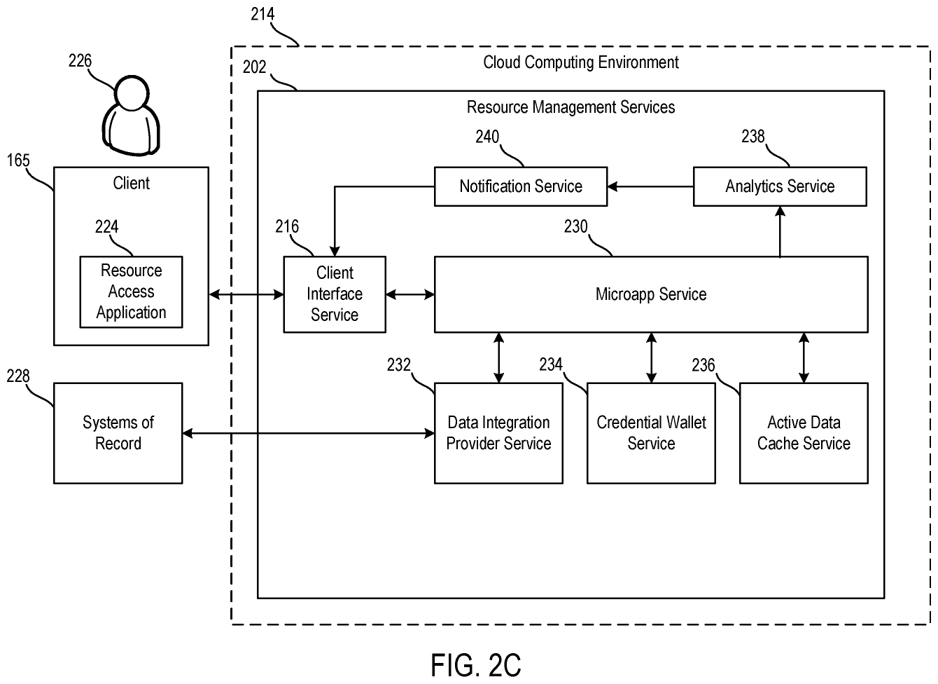

FIG. 2A is a block diagram of an example system 200 in which one or more resource management services 202 may manage and streamline access by one or more clients 165 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of the illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®), one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well as a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (4) restricting navigation, e.g., by disabling the next and/or back browser buttons, (5) restricting downloads, e.g., by disabling the ability to download from within the SaaS application, and (6) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface—without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted OAuth2 token for the system of record for which the action is to be invoked, and may send the action to the data integration provider service 232 together with the encrypted OAuth2 token. The data integration provider service 232 may then decrypt the OAuth2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back end. In some embodiments, users may be able to interact with the virtual assistance through either the resource access application 224 or directly from another resource, such as Microsoft Teams. This feature may allow employees to work efficiently, stay organized, and delivered the specific information they are looking for.

### C. Systems and Methods for End-Point Instance Indexing and Owner Point-of-Presence (POP) Selection

A client device can access resources on a cloud service, server, or remote device by establishing a session with a machine (e.g., virtual or physical machine). Prior to establishing the session, the client device may communicate with a POP to create and receive a ticket including properties of the client device or the POP. The ticket, among other tickets, can be stored at a data center or a particular POP. Once the POP receives a ticket request from the client device (e.g., to process the ticket to authenticate the user, update the ticket, delete the ticket, etc.), the POP can fetch the ticket from the data center or the POP storing tickets for client devices. However, due to the ticket being stored on one POP or cloud provider, the POP or cloud provider may be overloaded or flooded with traffic requesting for the ticket or to process the ticket themselves. Further, if the POP or cloud provider becomes unavailable, disconnects, or goes down, the generated tickets stored on the POP may be deleted or become unavailable to the client devices or other POPs.

The systems and methods of this technical solution can index to multiple end-point instances and select owner POPs for storing or handling the tickets. For example, the systems and methods can organize the POPs into different groupings (e.g., bindings) based on similarities in their properties (e.g., geographical region, naming connection, associated cloud providers, etc.) indicated by a configuration (e.g., functions, rules, binding techniques, selection techniques, etc.) for ticket ownership. The configuration can be configured or modified by the administrator or the operator of the POPs or cloud providers, for example. Similarly, the systems and methods can select owner POP(s) from at least one group satisfying the constraints or properties indicated by the configuration.

Upon selection, the POPs can be configured as the owner of the ticket. The systems and methods can use the configuration to perform any update to the tickets stored in local storages of the owners or update the organization of the POPs in the various bindings or groups, such as adding, deleting, or updating tickets, and adding or removing POPs from various bindings. Accordingly, the systems and methods described herein can at least enhance the resiliency of ticket availability (e.g., by storing the tickets in multiple POPs and cloud providers), reduce resource consumption from regenerating tickets when certain POPs or cloud providers are offline, and minimize the impact on tickets availability and POPs availability when adding or deleting POPs.

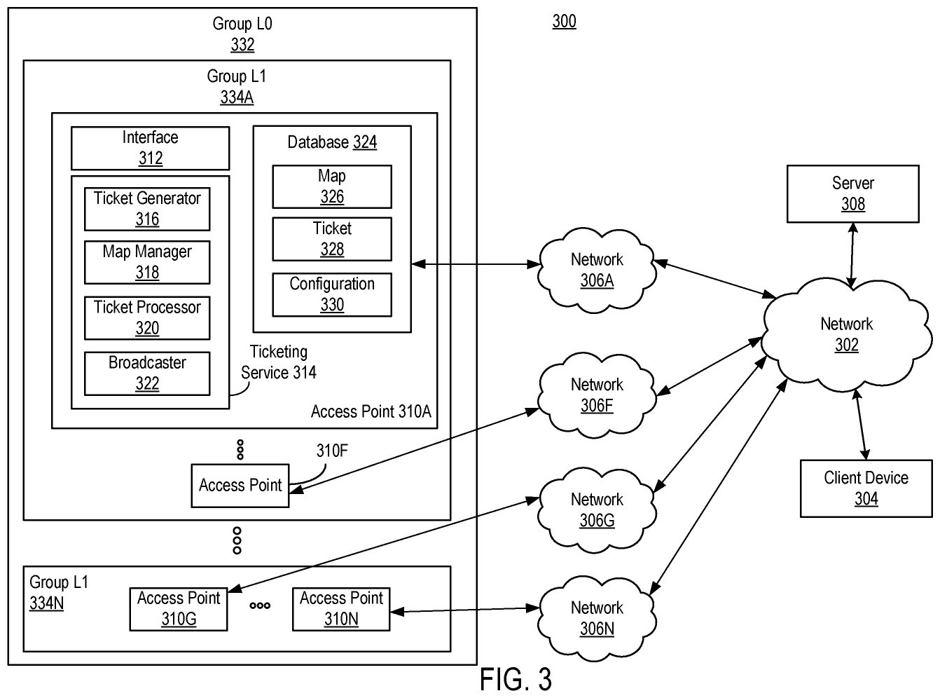

Referring to FIG. 3, depicted is a block diagram of one embodiment of a system 300 for end-point instance indexing and owner POP selection. The system 300 can include at least one network 302 (e.g., centralize network), at least one client device 304, various networks 306A-N (e.g., sometimes referred to as network(s) 306), at least one server 308, and various access points 310A-N (e.g., sometimes referred to as access point(s) 310) within one or more groups 334A-N (e.g., sometimes referred to as group(s) 334). The groups 334 can be subsets of a group 332 (e.g., a parent group). The group 332 can be at level 0 (L0), which encapsulates or includes various subset groups (e.g., groups 334) at level 1 (L1), or other groups of lower levels (e.g., L2, L3, etc.). Although shown as the parent of other subset groups, the group 332 may be a subset of another group.

The components (e.g., network 302, client device 304, network 306, server 308, or access point 310) of the system 300 can include or be composed of hardware, software, or a combination of hardware and software components. The one or more components (e.g., network 302, client device 304, network 306, server 308, or access point 310) of the system 300 can establish communication channels or transfer data via the network 302 or a respective network 306. Individual networks 306 can be associated with or linked to a respective access point 310 (e.g., network 306A connected to or coupled to access point 310A, network 306F connected to access point 310F, network 306G connected to access point 310G, network 306N connected to access point 310N, etc.). For example, the client device 304 can communicate with at least one of the access point 310, the server 308, or other external devices via the network 302. In another example, the access point 310 can communicate with other devices, such as the client device 304 via the network 302 and the respective network 306, and vice versa. The communication channel between various different network devices can communicate with each other via the network 302 or different networks 302. In further example, communications with at least one of the access points can be via the network 302, a respective network 306, or both the networks 302 and 306. Hence, hereinafter, communications through the network 302 can be interchangeable with the network 306, such as when communicating with the access point 310.

The network 302 (or the network 306) can include computer networks such as the Internet, local, wide, metro or other area networks, intranets, satellite networks, other computer networks such as voice or data mobile phone communication networks, and combinations thereof. The network 302 may be any form of computer network that can relay information between the one or more components of the system 300. The network 302 can relay information between client devices 304 and one or more information sources, such as web servers or external databases, amongst others. The network 302 can relay information between access points 310 or from any access point 310 to other devices within the network 302. In some implementations, the network 302 may include the Internet and/or other types of data networks, such as a local area network (LAN), a wide area network (WAN), a cellular network, a satellite network, or other types of data networks. The network 302 may also include any number of computing devices (e.g., computers, servers, routers, network switches, etc.) that are configured to receive and/or transmit data within the network 302. The network 302 may further include any number of hardwired and/or wireless connections. Any or all of the computing devices described herein (e.g., client device 304, server 308, access point 310, etc.) may communicate wirelessly (e.g., via WiFi, cellular, radio, etc.) with a transceiver that is hardwired (e.g., via a fiber optic cable, a CAT5 cable, etc.) to other computing devices in the network 302. Any or all of the computing devices described herein (e.g., client device 304, server 308, access point 310, etc.) may also communicate wirelessly with the computing devices of the network 302 via a proxy device (e.g., a router, network switch, or gateway). In some implementations, the network 302 (or the network 306) can be similar to or can include the network 170 or a computer network accessible to the computer 100 described herein above in conjunction with FIG. 1A or 1B.

The system 300 can include or interface with at least one client device 304 (or various client devices 304). Client device 304 can include at least one processor and a memory, e.g., a processing circuit. The client device 304 can include various hardware or software components, or a combination of both hardware and software components. The client devices 304 can be constructed with hardware or software components and can include features and functionalities similar to the client devices 165 described hereinabove in conjunction with FIGS. 1A-B. For example, the client devices 165 can include, but is not limited to, a television device, a mobile device, smart phone, personal computer, a laptop, a gaming device, a kiosk, or any other type of computing device.

The client device 304 can include at least one interface for establishing a connection to the network 302 (or the network 306). The client device 304 can communicate with other components of the system 300 via the network 302, such as the access point 310 or the servers 308. For example, the client device 304 can communicate data packets with one or more servers 308 via the network 302. The client device 304 can communicate with the access point 310 via the network 302 or the network 306. The client device 304 can transmit a session request to the server 308 or the access point 310. The client device 304 can transmit a ticket request to the access point 310, such as to process a ticket. In some cases, the client device 304 can communicate with other client devices 304.

The client device 304 can include, store, execute, or maintain various application programming interfaces (“APIs”) in the memory (e.g., local to the client device 304). The APIs can include or be any types of API, such as Web APIs (e.g., open APIs, Partner APIs, Internal APIs, or composite APIs), web server APIs (e.g., Simple Object Access Protocol (“SOAP”), XML-RPC (“Remote Procedure Call”), JSON-RPC, Representational State Transfer (“REST”)), among other types of APIs or protocol described hereinabove in conjunction with clients 165 of FIG. 1B. The client device 304 can use at least one of various protocols for transmitting data to the server 308. The protocol can include at least a transmission control protocol (“TCP”), a user datagram protocol (“UDP”), or an internet control message protocol (“ICMP”). The data can include a message, a content, a request, or otherwise information to be transmitted from the client device 304 to a server 308. The client device 304 can establish a communication channel or a communication session with a server 308 and transmit data to the server 308. In some cases, the client device 304 can establish or connect to the session via a ticket request sent to the access point 310 (e.g., for processing, authorization, etc.). In some cases, the data packets from the client device 304 may be intercepted by the access point 310 or forwarded by the server 308 to the access point 310. For instance, when requesting for a session or to reestablish the session with the server 308, the server 308 may send a ticket request to an access point 310 or respond to the client device 304 to send a ticket request to the access point 310.

The system 300 can include or interface with one or more servers 308. The server 308 may be referred to as a host system, a server, a cloud device, a remote device, a remote entity, or a physical machine. One or more of the servers 308 can include, be, or be referred to as a remote devices, remote entities, application servers, or backend server endpoints. The server 308 can be composed of hardware or software components, or a combination of both hardware or software components. The server 308 can include resources for executing one or more applications, such as SaaS applications, network applications, or other applications within a list of available resources maintained by the server 308. The server 308 can include one or more features or functionalities of at least resource management services (e.g., resource management services 202) or other components within the cloud computing environment (e.g., cloud computing environment 214), such as in conjunction with FIGS. 2A-C. The server 308 can communicate with the client device 304 via a communication channel established by the network 302, for example.

The server 308 can handle traffic from other devices, such as the client device 304, the access points 310, among other devices of the network 302. The server 308 can provide the access to applications, resources, or features through established communication sessions. The server 308 can communicate with one or more access points 310 to authenticate the client device 304 or process a ticket from the client device 304, for example. If the server 308 receives confirmation or verification from the access point 310 from authenticating the client device, the server 308 can host a session (e.g., establish a session) for the client device 304 or reconnect the user to an existing session.

The system 300 can include various access points 310 associated with a respective network 306. The access point 310 may be referred to as a point-of-presense (POP), an appliance, a node, or an end-point instance. The access point 310 can include various components to bind or assign various access points 310 to individual groups 334. Further, the access point 310 can include the various components to select or determine owner access points (e.g., owner POPs or owner instances) for respective tickets. The access point 310 can include at least one interface 312. The access point 310 can include at least one ticketing service 314. The access point 310 can include at least one database 324. The database 324 can include map storage 326, which can store a map of the access points (e.g., data structure or tree structure), for example. The database 324 can include ticket storage 328, which can store one or more tickets owned by the ticketing service 314, for example. The database 324 can include configuration storage 330, which can store the configuration (e.g., rules or policies) for individual groups, for example. The ticketing service 314 (e.g., sometimes referred to as ticketing instance, service instance, or ticketing service instance) can include at least one ticket generator 316. The ticketing service 314 can include at least one map manager 318. The ticketing service 314 can include at least one ticket processor 320. The ticketing service 314 can include at least one broadcaster 322.

Individual components (e.g., interface 312, ticketing service 314, or database 324) of the access point 310 can be composed of hardware, software, or a combination of hardware and software components. Individual components of the access point 310 can be in electrical communication with each other. For instance, the interface 312 can exchange data or communicate with the ticketing service 314 or the database 324. The one or more components of the access point 310 can be used to perform features or functionalities, such as adding access point(s) 310 to or removing access point(s) 310 from one or more groups 344, updating a map (e.g., a map structure indicating the bindings of different access points 310 to groups 334, etc.), updating ticket(s) (e.g., locally stored tickets), processing ticket request, etc. The access point 310 can include other components to perform the features or functionalties discussed herein.

The interface 312 can interface with the network 302 (or network 306), devices within the system 300 (e.g., client devices 304 or servers 308), or components of the access point 310. The interface 312 can include features and functionalities similar to the communication interface 115 to interface with the aforementioned components, such as in conjunction with FIG. 1A. For example, the interface 312 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 312 can include at least a built-in network adapter, network interface card, PCMCIA network card, EXPRESSCARD network card, card bus network adapter, wireless network adapter, USB network adapter, modem, or any other device suitable for interfacing one or more devices within the system 300 to any type of network capable of communication. The interface 312 can communicate with one or more aforementioned components to receive, for example, information from the client devices 304 (e.g., geographical location, ticket request, application or resources requested, etc.) or the servers 308 (e.g., ticket request forwarded from the client device 304, etc.). The interface 312 can communicate with the one or more aforementioned components to transmit, for example, a confirmation of authorization, an indication of another access point 310 servicing or handling the ticket request, among other information from the ticketing service 314 or the database 324 to the client device 304 or the server 308.

The ticketing service 314 can be hosted on a respective access point 310. For example, access point 310A can host a first ticketing service and access point 310F can host a second ticketing service. The ticketing service 314 can be configured to issue session tickets in response to connection requests from the client device 304 (e.g., connection to an application or resources of the server 308 or a cloud provider). These tickets can be used for authentication or authorization to establish or re-establish a communication session for accessing the resources. The ticketing service 314 can be bound to an access point 310 or bound globally (e.g., multiple or group(s) of access points 310). Communications can be secured between the gateway service 208 of a server 308 (or a cloud computing environment 214) and the ticketing service 314 (or the access point 310) to process incoming connection requests or process tickets from client devices 304.

The ticket generator 316 can generate at least one ticket in response to a request to establish a session or access resources. The ticketing service 314 can receive the request via the interface 312 directly from the client device 304 or indicated by the server 308 receiving the access request. The ticket generator 316 can issue the generated ticket to the client device 304. In some cases, the ticket generator 316 can issue the ticket to the server 308. The ticket can include information associated with the client device 304 or resource (or application) being requested. The ticket can be used by the client device 304 or the server 308 to authenticate or verify the identity of the client device 304 for connection to a session on the server 308. The ticket can include, for example, at least the IP address (e.g., source or destination address) of the client device 304, the IP address of the server 308 assigned to or requested by the client device 304, among other information provided in the access request or data packet from the client device 304. In some cases, the ticket generator 316 can generate a ticket associated with a unique identifier including, for instance, values, characters, symbols, etc. For the purposes of an example discussed herein, a ticket can include a unique value associated with a session for the client device 304.

The ticket generator 316 can communicate with the map manager 318 to determine the multiple owners of the ticket. The ticket generator 316 can receive an indication from the map manager 318 of the various owners, which may or may not include the access point 310 that generated the ticket. For example, the ticket generator 316 can store the generated ticket in the database 324 local to the access point 310, if the access point 310 is one of the owners of the ticket. If the access point 310 is not the owner of the ticket, the ticket may not be stored in the database 324 of the non-owner access point. The ticketing service 314 (e.g., broadcaster 322) can provide or forward the ticket to all owners (e.g., indicated by the map manager 318) for local storage. In some cases, the ticket generator 316 of an access point 310 that generates and issues the ticket to the client device 304 can be one of the owners. In some other cases, the ticket generator 316 issuing the ticket may not be the owner, based on the configuration (e.g., policies, rules, functions, etc.) set by the administrator of the access points 310, the cloud provider, or the server 308, for example.

The map manager 318 can generate, manage, or update a data structure including various groups 334 of access points 310. The map manager 318 can divide or distribute the available access points 310 to various groups or bindings based on the configuration (e.g., a first set of rules). Further, using the configuration, the map manager 318 can select or determine the owner access point (e.g., owner POP or owner instance) from the groups 334 (e.g., using a second set of rules). The map manager 318 can organize the access points 310 (e.g., an indication of various available access points 310) into a preselected type of data structure, such as an n-ary tree structure (e.g., used as an example herein), or other types of data structures.

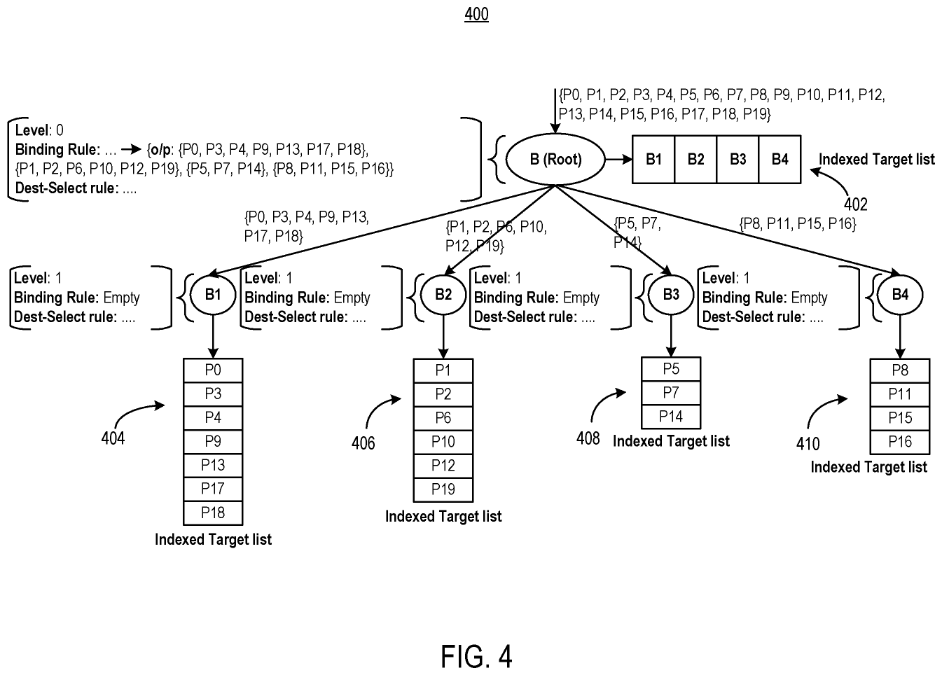

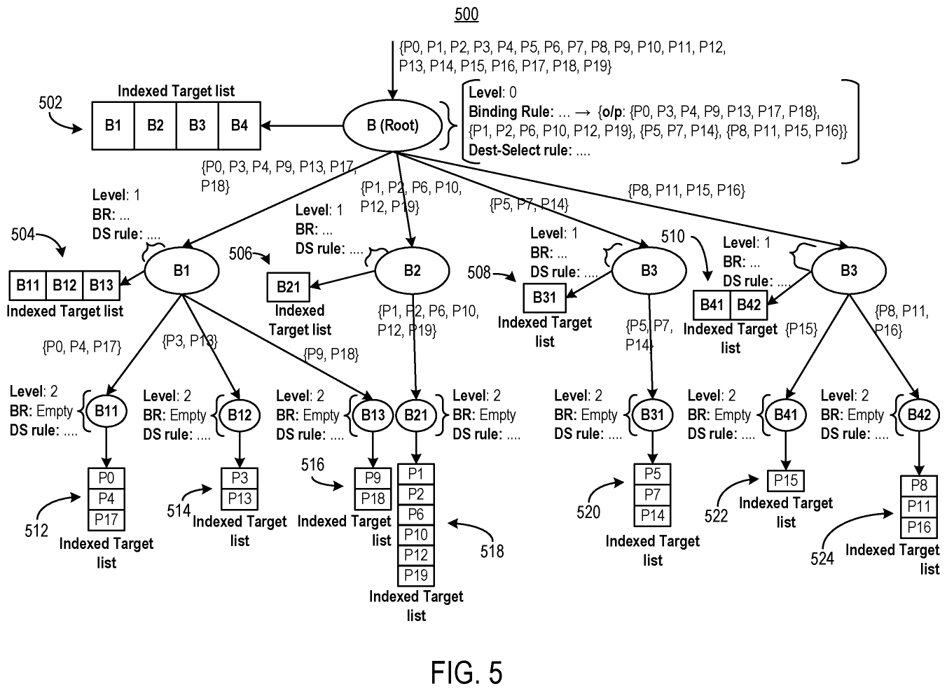

With an n-ary tree structure (or other types of data structures), the map manager 318 can determine the owner access points or owner ticketing services using a top-down rule-based selective path traversal technique(s) based on the configuration. Examples of the generated data structures can be shown in conjunction with FIGS. 4-5. For instance, individual groups (e.g., group 332 and groups 334) may be similar to or correspond to individual nodes within the data structures.

As shown in FIG. 3, group 332 (e.g., at level 0) can correspond to a parent node, and groups 334 (e.g., at level 1) can correspond to the children of group 332. With additional levels, such as level 2, level 3, etc., the lower level group(s) can be the child or children of the respective higher-level group(s). For instance, a level 2 group can be the child of the level 1 group, and the level 2 group can be a parent of a level 3 group. With each path of the data structure, the lowest level group or the group without a child or children groups (e.g., sometimes referred to as leaf node(s)) can be associated with individual access points 310. For instance, group 334A (e.g., one of the leaf node) can carry or include pointers, indices, a table, a list, a metric, or indicators associated with the access points 310A-F, as shown in FIG. 3. Similarly, for example, group 334N can carry pointers to access points 310G-N. The group 332 (e.g., non-leaf node) can carry pointers or indices to the children groups 334 (e.g., all subtrees) under the parent group. The map manager 318 can add or delete any access point 310 using a similar technique or configuration. The map manager 318 can adjust, update, or modify the subtree or at least one group 334 to add or remove the access point 310 as discussed herein.

The map manager 318 can form the groupings, bindings, or subtrees based on the configuration or rules. The non-leaf node(s) (e.g., group 332) can include or be configured with at least one respective rule (e.g., referred to herein as a binding rule). The map manager 318 can use the binding rule of the group 332 to distribute access points 310 under the various logical bindings, subtrees, or groups 334. In some cases, the map manager 318 can use the binding rule to generate or create a new group (e.g., leaf node) under which an access point 310 will be bind to. The groups 334 that the access points 310 are bound to can be the leaf nodes or the lowest leveled group within the respective subtree.

The binding rule can be based on one or more properties or information associated with individual access points 310. The binding rule can be based on the cloud provider associated with the one or more access points 310, the geographical location (e.g., sometimes referred to as geo) of individual access points 310, the naming convention (e.g., identification or client configured code) for the access points 310, date or time access points 310 are added or updated, versions of the access points 310, among other properties to bind various access points 310 into groups. For example, if the binding rule is configured as or based on the respective cloud provider, a first group of access points 310 can be associated with a first cloud provider (e.g., cloud provider A), a second group of access points 310 can be associated with a second cloud provider (e.g., cloud provider B), etc. In another example, if the binding rule is based on geographical location, the first group of access points 310 can be located within a certain radius of a landmark or location on the map, the second group of access points 310 can be located within another radius (e.g., may be the same or different distance) of another location on the map, etc. In some cases, the one or more access points 310 within a particular group may not be associated with another group. In some other cases, an access point 310 can be associated with multiple groups 334 or leaf nodes.

The map manager 318 can use these properties of the access points 310 to bind the access points 310 into a group (e.g., group 334 at level 1 or other groups at the lowest level of a branch in the data structure). Accordingly, with the groups (e.g., groups 332 and 334) including the binding rule, the map manager 318 can traverse various branches, paths, or subtrees with the data structure to determine the placement of one or more access points 310 within a particular group.

In some cases, based on the property of an access point 310, the map manager 318 may generate an additional subtree or children node (e.g., another group 334) to carry a pointer to the access point 310. For instance, the access point 310 may be located at a geographical location or include a naming convention dissimilar to other access points 310 (e.g., or one or more properties that should not be grouped with other access points 310), such that a new subgroup or subtree can be created to include the access point 310.

Similar to the binding rule associated with the group 332, various nodes (e.g., leaf nodes or non-leaf nodes) can include or be configured with a destination selection rule (e.g., sometimes referred to as “DestSelect rule”). The binding rule and the DestSelect rule can be parts of the configuration. The map manager 318 can use the DestSelect rule to identify the next group or node when traversing the data structure. The DestSelect rule can be configured by the administrator of the server 308, the access points 310, or the group, for example.

For example, the map manager 318 can use the DestSelect rule to traverse the data structure to determine at least one of the groups 334 that includes the owner for a ticket. Further, the map manager 318 can use the DestSelect rule to determine or select one or more access points 310 within a group 334 that is the owner of the ticket. In another example, the leaf node (e.g., group 334) can include the DestSelect rule without the binding rule to select the owner access point (e.g., owner POP or owner instance) from the list of access points 310 associated with the leaf node. Although the DestSelect rule can follow or be based on any logic or property to determine the next node for the traversal of the data structure, for the purposes of examples discussed herein, a key hash indexing technique can be used to detect or determine the target(s) (e.g., the owners) of the ticket. Additionally, using the key hash indexing technique, various targets or access points 310 can be mapped onto an indexed array (e.g., each group 332 can include at least one array, where each index within the array represents a particular access point 310). In some cases, the array can be a table, a list, among other types of organization of the access points 310 in a group 334). Accordingly, by hashing individual tickets and taking the modulus of the hashed tickets, the map manager 318 can select one or more access points 310 as the owner or the destination of the ticket(s) (e.g., the access point 310 to store the ticket or with the ticket stored).

In this example, as described hereinabove, the DestSelect rule in the key hash indexed technique can be (index=hash (ticket) modulus target_count). The map manager 318 can receive the ticket from the client device 304 or the server 308 (e.g., included in the ticket request). The map manager 318 can utilize any hashing technique to convert the identifier of the ticket to a unique value of the ticket. The modulus target_count can correspond to the number of indices (e.g., the number of access points 310 within the leaf node) or subgroups (e.g., the number of groups 334 or subtrees below the group 332). Hence, the modulus of the hashed ticket can correspond to a subgroup to select or an index within the array of the group 334. For the DestSelect rule configured for a non-leaf node, the “index” can represent the subgroup or the subtree of the non-leaf node. For the DestSelect rule configured for the leaf node, the “index” can represent the owner access point.

In various cases, the DestSelect rule can be configured with or include a weighted mechanism for selecting the one or more groups 334 or access points 310 over a predefined weight. The DestSelect rule can dynamically configure the weight based on the conditions of the groups 334 or access points 310. For example, the weight can be based on the traffic distributed to the respective destination (e.g., higher traffic group 334 or access point 310 can result in lower weight). The map manager 318 may traverse the tree structure to the destination (e.g., the access point 310) according to the weight indicated by the DestSelect rule (e.g., highest weighted groups 334 or access point 310). In another example, the weight can be based on a predefined property of the access point 310 (e.g., or predefined by the administrator), such as the local storage capacity, creation date, geographical location, among other properties of individual access points 310. Accordingly, the map manager 318 can traverse the groups 332 or 334 and select one or more access points 310 based on the predefined weight. The types of weight can be similar or different between the DestSelect rule of various groups 332 or 334.

The DestSelect rule can include a number of targets to select for each traversal. The number of targets can refer to the number of groups 334 or access points 310 to select for a particular ticket. For example, the group 332 can be configured with DestSelect rule to select two subgroups. The DestSelect rule can be configured with multiple indexing techniques for selecting the two subgroups, such as (index=hash (ticket) modulus target_count) and (index=(hash (ticket) modulus target_count)+1). Other types of mechanisms or techniques can be used to determine the two groups 334 or access points 310 to select. Hence, more than one path or more than one access point 310 can be selected to store the ticket (or access the tickets). For the purposes of providing examples, and for simplicity, the DestSelect rule can be configured as (index=hash (ticket) modulus target_count), however, other techniques or path traversal mechanisms can be used to perform the traversal of the data structure.

To generate the data structure (e.g., n-ary structure), the map manager 318 can take or obtain inputs from the administrator (e.g., over a configuration file) regarding the configuration (e.g., binding rule(s) and DestSelect rule(s)) during the bootup or initiation of the ticketing services 314 of access points 310. The map manager 318 can use the rules or configuration to distribute the access points 310 to different groups 334 and to traverse the groups 344 to select at least one access point 310. In some cases, the configuration can be updated at runtime.

Once the inputs are obtained, and the map manager 318 can access the configuration, the map manager 318 can generate a root node for the data structure (e.g., group L0 of FIG. 3). At this process, the root node may not include any child node. The root node can be configured with a binding rule and a DestSelect rule. The map manager 318 can group the access points 310 to various groups 334 based on the binding rule. The map manager 318 can insert the access points 310 or the groups 334 pointing to the access points 310 under the root node to create the n-ary tree placement with available access points 310.

For example, during the insertion of an access point 310 under any node, such as node N, including the root node, if node N (e.g., parent of the access point 310) includes or is configured with a valid binding rule, the map manager 318 can identify or check for any available target or child node (e.g., subgroup) under node N which has a matching property. If the subgroup includes a similar property, the map manager 318 can place or insert the access point 310 under the respective group 334 based on or according to the binding rule. The map manager 318 can perform similar operations for inserting any subsequent access points 310. In this case, among other examples, inserting the access point 310 under node N (or other parent nodes) may correspond to the traversal of the data structure to identify a group with an indexed array for inserting the access point 310.

In some cases, the map manager 318 may determine that no matching target or subgroup is found for the access point 310 based on the configured binding rule. In this case, the map manager 318 may introduce, create, or generate a new target, node or subgroup under the node N (e.g., another group 334 under group 332). The newly generated subgroup can include one or more properties associated with the particular access point 310, which can be configured as part of the configuration or binding rule of the subgroup. For instance, if the type of binding rule is based on the cloud provider, the new subgroup can include a binding rule associated with a cloud provider different from other subgroups. The newly added access point 310 can read or access its binding rule and DestSelect rule from the configuration. Accordingly, the map manager 318 can continue the insertion of other access points 310 in similar manner.

The map manager 318 can traverse through the data structure to identify one or more nodes without a binding rule (e.g., empty binding rule). In this case, the map manager 318 can determine that the node without the binding rule is the leaf node (e.g., an empty binding rule indicates that there is no subgroup below the node). Upon determining that the node is a leaf node, the map manager 318 can place or insert the access point 310 directly in the indexed array (e.g., table, list, etc.) of the leaf node. The array can include one or more other access points 310 with a similar property as the inserted access point 310. The map manager 318 can continue or reiterate the process of inserting access points 310 under leaf nodes to generate the data structure guided by the binding rule, for example.

In various instances, nodes at a certain level in the data structure can share a common binding rule or DestSelect rule, or individual nodes can be configured with a unique binding rule or DestSelect rule. To determine or select the owner access point 310 for a particular ticket, the map manager 318 can execute the hash operation (e.g., such as described hereinabove) and initiate the traversal from the root node (e.g., parent of all nodes). When traversing various paths, the map manager 318 can determine whether the child node of the root node or any subsequent nodes from the root node is a leaf node or a non-leaf node. If the child node is a non-leaf node, the map manager 318 can identify or determine the next node or set of node(s) for the traversal based on the associated DestSelect rule of the child node.

The map manager 318 can reiterate the process until a leaf node is found. If the child node is a leaf node, the map manager 318 can select at least one access point 310 from the indexed array using the DestSelect rule from the configuration of the leaf node. The access points 310 found via the traversal of the data structure can constitute or correspond to the owner access points 310 for the respective ticket. Subsequent to traversing the data structure to find the owner, the map manager 318 can determine whether to forward a ticket request received from another device of the network 302 or process the request. For instance, based on the results from the map manager 318, the access point 310 can determine whether it is the owner. If not the owner, the map manager 318 can inform the broadcaster 322 to transfer or forward the request to the identified owner(s) carrying a copy of the ticket in their local storage. Otherwise, if the respective access point 310 is the owner, the map manager 318 can provide the ticket request to the ticket processor 320 for processing the request.

The map manager 318 can provide one or more ticket(s) for storage on multiple access points 310 associated with different clouds (e.g., cloud providers). For example, subsequent to the creation of a ticket and based on the configuration associated with different nodes (e.g., the root node and subgroups), the map manager 318 can determine that the owner access points of the ticket are associated with different cloud providers. Accordingly, the map manager 318 can inform the broadcaster 322 to forward the ticket to the respective target or destination owners, thereby creating the ticket on multiple clouds (e.g., multiple heterogenous clouds) that can be administered by different administrators of the respective clouds.

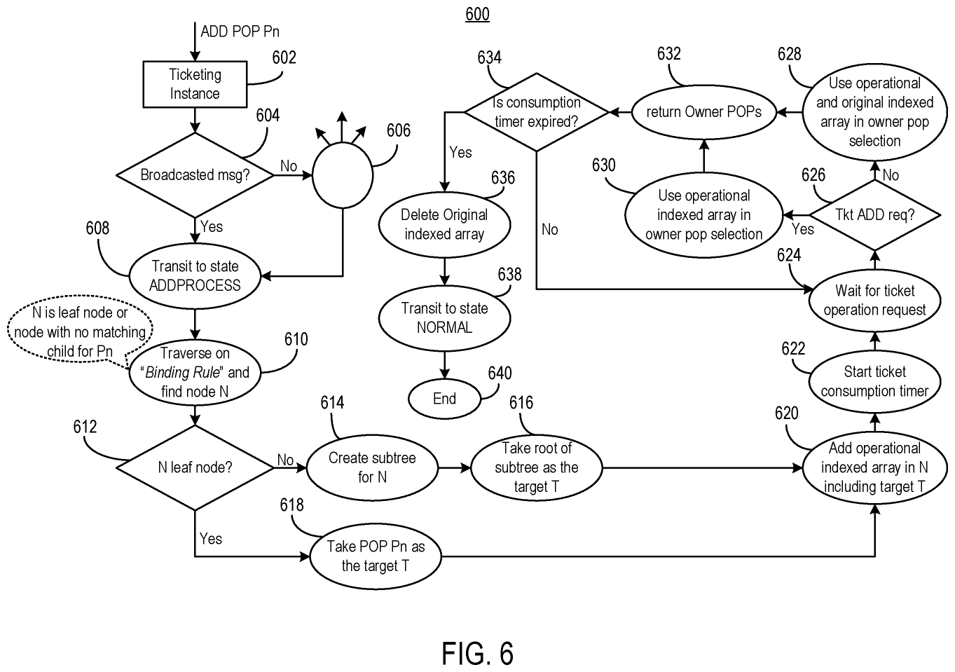

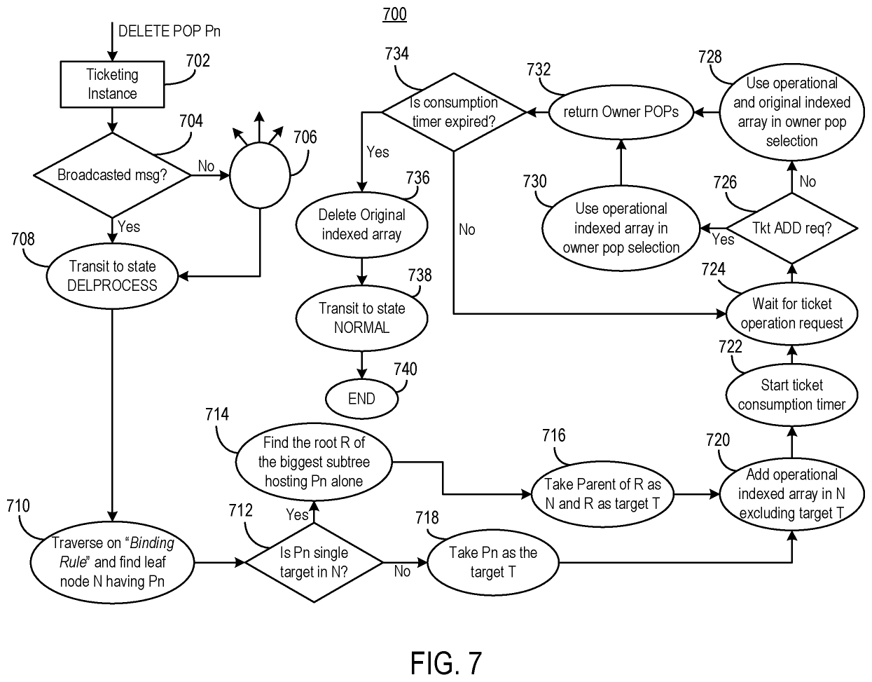

Similar operations or processes can be applied to adding or removing the access points 310 from one or more groups 334, such as described in at least FIGS. 6-7. For example, the map manager 318 can receive a request to add an access point 310. The map manager 318 can determine, based on the rules from the configuration (e.g., using the function) associated with individual groups 334 (e.g., the root node, non-leaf node, or leaf node), at least one of the groups 334 (e.g., a leaf node) to add the access point 310 under. The at least one particular group can include one or more other access points with similar property as the access point 310 to be added. The map manager 318 can add the access point into an array of the group (e.g., the array can represent a group) including indices, each index representing or associated with a respective access point 310.

In various aspects, by adding a new access point 310 to a group, a new array (e.g., a second array or list) can be generated. The new array can include the newly added access point 310 and all other access points 310 from the previous array (e.g., the first array). The map manager 318 can determine a timestamp (e.g., a first timestamp) associated with the request to add the access point 310 to associated with the second array. In this case, when the map manager 318 receives a request to process a ticket, and the owner of the ticket is a part of the group with multiple arrays, the map manager 318 can compare a timestamp (e.g., a second timestamp) of when the ticket corresponding to the request is generated to the first timestamp. Based on the comparison, if the second timestamp is earlier than the first timestamp, the map manager 318 can use the first array or list of access points 310 to identify the owner for processing the ticket request. Otherwise, if the second timestamp is at or after the first timestamp, the map manager 318 can use the second array to determine the owner for processing the request.

In some cases, when the ticket that is created before the second array has been processed (e.g., using the first array to determine the owner), the map manager 318 can update the ticket to be compatible with the second array. For example, the map manager 318 can update the time of the ticket to reflect a creation date at or after the first timestamp when generating the second array. The configuration can be configured with expiration information (e.g., duration from the time the second list is generated until the first list expires) for tickets or the array of indices. The map manager 318 can compare the duration since the creation of the second list to a predetermined threshold to determine an expiration of the first list. Upon determining that the first list is expired (e.g., expiration of tickets in the first list that has not been updated to the second list), the map manager 318 can remove the list accordingly. Hence, based on this example operation, eventually, one or more tickets from the first list can be transferred to the second list via an update, or tickets from the first list may expire and be removed, thereby enabling the map manager 318 to use the second list for subsequent ticket requests. In various implementations, the map manager 318 can generate additional arrays or lists based on the number of newly added access points 310, for example.

To delete an access point 310, the map manager 318 can receive the request to delete the access point 310, such as from the server 308. The deletion of the access point 310 can be performed in similar operation(s) as when determining an owner or when adding an access point 310. For example, the map manager 318, responsive to receiving the requets to delete an access point, can determine a group that includes the access point 310 to be deleted based on the function, configuration, or rule(s). Subsequently, the map manager 318 can identify and remove, based on the configuration, the access point 310 associated with the deletion request. In some cases, the map manager 318 can determine that the removed access point 310 is the only access point 310 within the group 334 (e.g., the list of the group 334 includes one index associated with the access point 310). Since this group 334 does not have any index in the array, the map manager 318 can remove or delete the group 334 from the various groups 334.

The ticket processor 320 can process the ticket received from the client device 304 or the server 308 responsive to determining that the access point 310 is the owner of the ticket. For example, the map manager 318 can determine whether the access point 310 is the owner of the ticket for the ticket request. If the access point 310 is the owner, the ticket processor 320 can initiate the ticket processing procedures or operations. Otherwise, the ticket request can be broadcasted or sent (e.g., by the broadcaster 322) to one or more other access points determined to be the owner, for example. The ticket processor 320 can serve or process the ticket request from the local storage (e.g., the owner stores the ticket in the database 324).

To process the ticket, the ticket processor 320 can authenticate the ticket request based on a comparison or verification between the ticket from the request and the ticket stored in the database 324. In some cases, the ticket processor 320 can compare the properties associated with the ticket of the request to the properties of the associated ticket (e.g., ticket with similar identification) stored in the database 324.

Once the ticket is processed, the ticket processor 320 can relay to the broadcaster 322 to provide an update of the ticket operation to other owners. In this case, the ticket operation can be reflected to other owners of the ticket. The ticket operation can include any status or operation performed on the ticket, such as ticket processing status (e.g., whether the ticket is being processed or has been processed responsive to the ticket request). In some cases, the ticket processor 320 can update the ticket associated with the ticket request. For example, the ticket processor 320 can receive additional information or properties associated with the client device 304 or the resources requested, such as new IP address, types of resources, time of ticket generation updated to the time of the ticket request, etc.

The ticket processor 320 can determine, subsequent to processing the ticket, the one or more servers 308 hosting the session of an application or resource for the client device 304 sending the ticket request. Once the ticket processor 320 verifies the identity of the client device 304 based on the processed ticket, the ticket processor 320 can establish or inform the one or more server 308 to establish the connection to the session of an application hosted by the one or more servers 308. In some cases, the ticket processor 320 can identify the cloud services (e.g., cloud providers) associated with the group 334 that the owner access point belongs to. Accordingly, responsive to processing the ticket (e.g., for authentication or verification of the user), the ticket processor 320 can establish or provide an indication to establish the connection to the session hosted by the one or more servers 308 of a cloud service that is associated with the access point 310 of the group 334. Although the processing of the ticket can include authentication of the user, as provided in examples herein, the ticket processor 320 can perform other operations to connect the user to a session, such as identifying a server 308 hosting the session based on the property or information of the ticket, etc. The session can be a newly generated session upon verification of the ticket or an existing session that the user is reestablishing or connecting to.

The broadcaster 322 can broadcast or provide the ticket request to one or more access points 310. The broadcaster 322 can broadcast the ticket request to one or more owner access points. For example, subsequent to the map manager 318 determining that the access point 310 is not the owner of the ticket, the broadcaster 322 can provide the ticket request to at least one other access point determined to be the owner (e.g., a first access point). In some cases, the broadcaster 322 can provide the ticket request to all the owners, where the owners can communicate with each other to determine the access point that will process the ticket. For instance, a first owner and a second owner (among other owners) can indicate their respective geographical location (e.g., which may be a part of the information of the data structure). Based on the geographical location, the owner closest to the client device 304 or the server 308 may serve the request. In some cases, the owner can determine the traffic corresponding to other owners, such that the owner with the least traffic may serve the request. In some other cases, the broadcaster 322 can provide the ticket request to the owner with the least traffic, geographically closest to the user, with the least latency, ready to serve the request, among other properties.

The broadcaster 322 can receive a response from one or more other access points indicating that the request is being served. As such, the access point 310 receiving the ticket request that is not the owner can correspond to or act as an intermediary between the client device 304 or the server 308 to the owner access point. As an intermediary, the broadcaster 322 can relay information between external devices and the owner access point(s). When the ticket is processed, the broadcaster 322 can receive a response from the owner access point 310 indicating, for instance, whether the user is or is not authorized to establish a communication with a session. In some cases, the broadcaster 322 can transmit a signal to the client device 304 or the server 308 indicating the owner access point handling the request. As such, the external devices can communicate directly to the owner access point that is serving the request. In some other cases, when the broadcaster 322 forward the request to one of the owners (e.g., the first access point), the broadcaster 322 can signal or provide an update to the remaining owners indicating that the first access point is processing the request, such that the request processing operations do not overlap. In some cases, the broadcaster 322 (or other components of the ticketing service 314) can update the ticket operation or ticket state to reflect that the ticket is being processed by one of the owners.

If the access point 310 is the owner and another access point (e.g., a first access point) receives the ticket request, the broadcaster 322 can receive the request from another access point for the ticket processor 320 to process and serve the ticket request. Upon processing the request, such as to determine whether the client device 304 is authorized to connect to a session, the broadcaster 322 can transmit a response to at least one of the client device 304, the first access point that forwarded the request, or the server 308, for example.

The database 324 may be referred to as a data repository, central storage, or memory of the access point 310. The one or more storages (e.g., map storage 326, ticket storage 328, or configuration storage 330) of the database 324 can be accessed, modified, interacted by one or more components (e.g., interface 312 or ticketing service 314 (or components of the ticketing service 314)) of the access point 310. In some cases, the one or more storages of the database 324 can be accessed by one or more other authorized devices of the system 300, such as an administrator device managing the access points 310 or the server 308. The database 324 can store input data for the ticketing service 314 or data output from the ticketing service 314. The database 324 can include other storages to store additional data from one or more components of the access point 310 or data from other devices of the system 300, for example.

The map storage 326 can include, store, or maintain a map of the groups 332 or 334 generated or obtained by the ticketing service 314 (e.g., the map manager 318). The map may refer to a data structure, a tree structure (e.g., n-ary tree structure as examples herein), groupings, binding, listing, or organization of the access points 310. The data structure can be updated dynamically, for example, by the map manager 318 responsive to receiving a request to add, remove, or update an access point 310. In some cases, the map storage 326 can include a timer or an expiration time associated with individual tickets of the respective access point 310. The map storage 326 can be configured by the administrator. The map storage 326 can store the map generated by the ticketing service 314 or other ticketing services of other access points. The information of the map storage 326 can be shared across other access points. The map storage 326 can store any other information related to the data structure or arrangement of the groups 332 or 334.

The ticket storage 328 can include, store, or maintain one or more tickets associated with one or more client devices 304. The ticket storage 328 can store information or properties associated with the ticket, such as a unique identifier of the ticket, available user information shared by the client device 304 (e.g., IP address, system information, operating system (OS), etc.), among others. The ticket storage 328 can be accessed by the map manager 318 to retrieve or obtain a ticket associated with the ticket request for authentication, such as to perform a comparison. The ticket storage 328 can store tickets generated by the ticket generator 316 or other ticket generators of other ticketing services. The tickets stored in the ticket storage 328 can indicate that the access point 310 is the owner of the ticket, and is thereby allowed to serve a ticket request with an associated ticket (e.g., similar to other owners). The ticket storage 328 can receive an update to at least one of the tickets by at least one of the ticket processor 320 or the broadcaster 322 responsive to the processing of the ticket.

In some cases, the ticket storage 328 can include an expiration time associated with individual tickets. The expiration duration can be configured by the administrator, the server 308, or the client device 304, for example. The expiration time can be started or triggered responsive to at least one of the generation of the ticket, a request to connect to a session, an indication of session inactivity, among others. The ticket storage 328 can be accessed by the map manager 318 to remove the ticket upon expiration of the timer. Changes to individual tickets can be reflected to the ticket(s) stored on other owner access point(s).

The configuration storage 330 can include, store, or maintain a configuration of the ticketing service 314. The configuration can include at least the binding rule and the DestSelect rule for examples discussed herein. The configuration storage 330 can be accessed by the administrator, the components of the ticketing service 314, among others, such as to update the configuration. For instance, the configuration storage 330 can be accessed by the administrator to change the binding rule (e.g., for how to bind individual access points 310 to groups 334) or the DestSelect rule to select one or more destinations for determining the owners of individual tickets. In another example, the configuration storage 330 can be accessed by the map manager 318 to determine the ownership of individual tickets, to add access point(s) 310, to remove access point(s) 310, to add a new group if one or more access points 310 does not fit under a certain pre-existing group 334, etc.

Referring to FIG. 4, depicted is an example diagram 400 of POP (e.g., access point) placement with one level binding rule. The operations discussed for placement of the access points 310 can be executed, performed, or otherwise carried out by one or more components of the system 300, including, for example, access point 310 (e.g., the ticketing service 314, etc.), the computer 100, the cloud computing environment 214, or any other computing devices described herein in conjunction with FIGS. 1A-2C. For example, the operations can be performed by the ticketing service 314 at least one access point 310 configured to generate or update a data structure (e.g., n-ary tree structure) organizing the various access points. As discussed herein, the ticketing service 314 can generate the diagram 400 or the data structure based on the configuration (e.g., the binding rule and the DestSelect rule).

For example, 20 ticketing instances hosted on respective 20 POPs (e.g., P0 to P19) can be placed on an n-ary tree having one binding rule for the root node. The binding rule can indicate a technique or configuration for distributing the access points 310 into different bindings or groups 334. In this case, P0 to P19 can be separated into four groups (e.g., B1 to B4 bindings). The groups can be indicated by an indexed target list, among other types of listing. The binding rule associated with the root node (e.g., B (root)) can indicate the bindings of subtrees or subgroups based on any property associated with the access points 310, such as cloud provider, geographical location, etc. In this case, based on the binding rule, the ticketing service 314 can separate or divide the access points to {P0, P3, P4, P9, P13, P17, P18} for B1 binding, {P1, P2, P6, P10, P12, P19} for B2, {P5, P7, P14} for B3, and {P8, P11, P15, P16} for B4. These subgroups linked directly from the root node (e.g., at level 0) can be at level 1. The bindings (e.g., B1 to B4) can be represented by an index of an indexed target array (e.g., indexed target list 402) of the node B.

Since this data structure includes one sublevel, the binding rules for the leaf nodes B1 to B4 can be empty, indicating that no further distribution of access points are under the node. Having an empty binding rule can further indicate that indices associated with the access points 310 are placed directly into the indexed array (e.g., at least one of the indexed target list 404, 406, 408, or 410) of the nodes (e.g., groups or bindings) in level 1. The ticketing service 314 can share the data structure (e.g., generated or updated data structure) to other access points 310.

The DestSelect rule of Level 0 can indicate the traversal path to the targets including B1, B2, B3, or B4. The targets {B1, B2, B3, B4} can be placed at indices 0, 1, 2, and 3 respectively in the indexed target list at the root node. For the purposes of examples, the DestSelect rule can be configured as (target=hash(ticket) modulus 4) and (target=hash(ticket) modulus 4)+1), however, other operations can be used to determine the traversal path responsive to the ticketing service 314 receiving the ticket request.

For example, using the arrangement of bindings and access points 310, when the ticketing service 314 generates a ticket, the ticketing service 314 can determine a hash value corresponding to the ticket. Using the configuration or function of the DestSelect rule, the ticketing service 314 may determine a hash value of 0x11223344 for the ticket. The ticketing service 314 can select B1 based on 0x11223344% 4 and B2 based on 0x11223344% 4+1 as the next nodes or targets for the traversal. Upon traversing to B1 subtree from the B (e.g., root node), the ticketing service 314 can determine that B1 is a leaf node with seven indices (e.g., access points 310).

Using the DestSelect rule at B1, the ticketing service 314 can select P0 (e.g., 0x11223344% 7) and P3 (e.g., (0x11223344% 7)+1)) as the owner instances from the indexed target list 404. Similarly traversing to B2 from B, the ticketing service 314 can also determine that B2 is a leaf node having six access points or indices within the indexed target list or indexed array. Hence, the ticketing service 314 can select P6 (e.g., 0x11223344% 6) and P10 (e.g., (0x11223344% 6)+1) as owners from the indexed target list 406. According to this example, the ticketing service 314 can return {P0, P1, P6, P10} as the owner access points for this ticket. Upon determining the owners, the ticketing service 314 can transfer, forward, or provide all owners with the ticket for locally storing a copy of the ticket. If B3 or B4 is selected based on the DestSelect rule of node B, one or more of the access points 310 can be returned from list 408 or 410, respectively.

In another example, the configuration can be configured with specific constraints by the administrator of the access points 310. For instance, the binding rule for B1 to B4 (e.g., cloud providers A to D, respectively) can be based on cloud providers. The DestSelect rule of B can indicate selections of any two cloud providers. In this case, the ticketing service 314 can select and traverse two of the B1 to B4. At level 1, individual groups associated with respective cloud providers can be configured with another DestSelect rule. If the DestSelect rule is select any two access points (among the various DestSelect rule configuration), the ticketing service 314 can select two access points from two of the binding groups. Other types of properties can be used or configured to perform the determination or selection of access points, such as any three access points, two access points based on geographical location, among other types or combination(s) of types. Hence, the configuration can guide the traversal of multiple binding groups and selections of multiple access points, such as selecting a total of four access points in this example. Therefore, the four selected owners can store copies of the ticket for serving ticket requests from their local storage.

Referring to FIG. 5, depicted is an example diagram 500 of POP placement with two-level binding rule. The operations discussed for creating or generating a data structure with two-level binding rule can be executed, performed, or otherwise carried out by one or more components of system 300, including, for example, the access point 310 (e.g., the ticketing service 314, etc.), the computer 100, the cloud computing environment 214, or any other computing devices described herein in conjunction with FIGS. 1A-2C. For example, the operations can be performed by the ticketing service 314 at least one access point 310 configured to generate or update a data structure (e.g., n-ary tree structure) organizing the various access points. The generation of the data structure of diagram 500 can be in part similar to the operations described in conjunction with FIG. 4. The ticketing service 314 can share the updated or generated data structure to other access points 310.

For example, referring to the example of FIG. 5 the ticketing service 314 can identify 20 access points (e.g., P0 to P19) for binding. The binding rule of node B (e.g., B (root)) can include an indexed target list 502 indicating indices associated with B1 to B4 (e.g., subgroups or subtrees). In this case, each of the nodes B1 to B4 can include a respective binding rule, which indicates that nodes B1 to B4 of level 1 are not the leaf node. Each of B1 to B4 can include a respective indexed target list, such as indexed target lists 504, 506, 508, and 510, respectively. The target lists 504, 506, 508, or 510 can include indices associated with the child node(s) under the respective B1, B2, B3, or B4 nodes. According to the binding rules of nodes B1 to B4, B1 can carry a pointer to or include subgroups {B11, B12, B13} (e.g., list 504), B2 can include {B21} (e.g., list 506), B3 can include {B31} (e.g., list 508), and B4 can include {B41, B42} (e.g., list 510). The binding rule associated with each level can be different.

For example, at node B of level 0, the ticketing service 314 can divide the groups based on the binding rule configured as cloud providers. Further, at nodes B1 to B4, the ticketing service 314 can divide the access points 310 into additional subset groups {B11, B12, B13, B21, B31, B41, B42} based on the binding rule configured as geographical location (e.g., different areas where the access points 310 are located). Other types of binding rules can be configured to bind the access points 310. Hence, as shown in FIG. 4, the ticketing service 314 can bind the access points 310 into two levels. Additional levels or layers can be introduced based on the configuration. As shown, the ticketing service 314 can use the binding rule at the first level (e.g., B1 to B4) to distribute the access points 310 into three sets {P0, P4, P17} (e.g., associated with indices of list 512 from B11), {P3, P13} (e.g., associated with indices of list 514 from B12), and {P9, P18} (e.g., associated with indices of list 516 from B13) for B1. The ticketing service 314 can distribute the access points 310 into a single set {P1, P2, P6, P10, P12, P19} for B2 (e.g., associated with indices of list 518 from B21). The ticketing service 314 can distribute the access points 310 into another single set {P5, P7, P14} for B3 (e.g., associated with indices of list 520 from B31). The ticketing service 314 can distribute the access points 310 into two sets {P15} (e.g., associated with indices of list 522 from B41) and {P8, P11, P16} (e.g., associated with indices of list 524 from B42) for B4.

To find the owner of a ticket (e.g., generated by the ticketing service 314 or received from the ticket request), similar operations as FIG. 4 can be performed. For example, the ticketing service 314 can hash the ticket to obtain 0x11223344 as the hash value. Based on the hash value, the ticketing service 314 can select B1 (e.g., 0x11223344% 4) and B2 (e.g., (0x11223344% 4)+1) as the next node for the traversal from node B. At B1, the ticketing service 314 can select B13 (e.g., 0x11223344% 3) and B11 (e.g., (0x11223344% 3)+1) as the next node for the traversal. At B2, since there is only one child node, the ticketing service 314 can select B21 as the target destination. As a result, the ticketing service 314 can select {B11, B13, B21} for traversal at level 2. Since the binding rule for level 2 is empty, the ticketing service 314 can determine that the selected bindings at level 2 are leaf nodes.

The ticketing service 314 can use the DestSelect rule associated with the respective leaf node for selecting one or more owners. For example, at B11, the ticketing service 314 can select P17 (e.g., 0x11223344% 3) and P0 (e.g., (0x11223344% 3)+1). At B13, since the DestSelect rule is configured two access points selection, the ticketing service 314 can select all the access points under B13 (e.g., P9 (0x11223344% 2) and P18 ((0x11223344% 2)+1)). At B21, the ticketing service 314 can select P6 (e.g., 0x11223344% 6) and P10 (e.g., (0x11223344% 6)+1). Accordingly, based on the traversal, the ticketing service 314 can return or output {P17, P0, P9, P18, P6, P10} as the owners for the ticket.

In some cases, based on the configuration, a weight can be applied for selection of one or more cloud providers, geographical location, among other properties associated with the binding rules of level 0 and level 1. The weight can be enforced on a certain amount of tickets, which the ticketing service 314 can redirect the ticket to one or more access points 310 based on the weight. Therefore, the ticketing service 314 can assign owners for a particular ticket based on the configuration and the weight. In some cases, increasing the weight of certain cloud providers or geographical locations (among others) can involve, for instance, adding or increasing the number of indices for the weighted nodes or access point indices. In this case, the weighted binding or access points can be represented by multiple indices. Other weighting techniques can be used to enforce a weight for assigning ownership to the tickets. In some cases, the ticketing service 314 can directly select one or more access points or bindings that are weighted based on properties or information from the ticket.

FIG. 6 illustrates an example flow diagram 600 for adding a POP (e.g., access point). The operations of diagram 600 can be executed, performed, or otherwise carried out by one or more components of the system 300, including, for example, ticketing service 314 (e.g., map manager 318, ticket processor 320, etc.) (among other ticketing services), the computer 100, the cloud computing environment 214, or any other computing devices described herein in conjunction with FIGS. 1A-2C. Certain operations can be performed in any order or out of order based on the generation, setup, or arrangement of the data structure.

At operation 602, the ticketing service 314 can receive a request or an indication to add an access point 310 (e.g., an ADD command). The new access point 310 may be introduced at runtime (e.g., add to the data structure dynamically). The ticketing service 314 can select the appropriate node in the data structure where the access point 310 corresponds to the desired configuration (e.g., the binding rule or DestSelect rule) to introduce the new access point in the leaf node or subtree. The ticketing service 314 can initiate the ADD process for adding an access point in response to receiving the ADD command from any access points.

At process 604, the ticketing service 314 can determine whether the message (or in this case the ADD command) has been broadcasted. For instance, if the ticketing service 314 receives the command directly from the server 308, cloud provider, etc., the ticketing service 314 can broadcast the command to other access points 310 (e.g., at operation 606). If the ticketing service 314 receives the command from another access point 310 or has already broadcasted the message to other access points 310, the ticketing service 314 can proceed to operation 608. At operation 608, the ticketing service 314 can transit or move to an “ADDPROCESS” state (e.g., a state where no further addition or deletion operations are allowed) from a “NORMAL” state (e.g., a state where updates to the data structure are allowed).

At operation 610, the ticketing service 314 can traverse the data structure based on the binding rule. The ticketing service 314 can compare or match the property of the new access point to various bindings. The ticketing service 314 can detect or determine a node (N) having no existing child node that matches the property for the new access point 310. To introduce the new access point under the node N, the ticketing service 314 can update the indexed array of node N with the new access point. At operation 612, the ticketing service 314 can determine whether node N is a leaf node. At operation 618, if the node N is a leaf node, the ticketing service 314 can insert the access point 310 directly into the indexed array of the node N (e.g., inserted as a new index in the array). As such, the target for inserting the new access point can be the array of node N.

At operation 614, if the node N is a non-leaf node, or if the property of the new access point does not match other existing bindings (or binding rule), the ticketing service 314 can form another subtree (e.g., subgroup or leaf node) for node N. At operation 616, the ticketing service 314 can take the root of the subtree as the target for inserting the new access point. The ticketing service 314 can populate the binding rule and DestSelect rule of the subgroup based on at least the property of the new access point different from other subgroups. Accordingly, in both scenarios, the ticketing service 314 can update the indexed array of the leaf node (e.g., the subtree or node N) to insert the new access point.

At operation 620, to introduce the new entry into the indexed array for both the mentioned cases of node N being leaf node or a non-leaf node, the ticketing service 314 can take certain measures to avoid incorrect selection of the owner for the ticket. For example, the ticketing service 314 can create a temporary (e.g., new) operational indexed array (e.g., a second array or a temporary array) in node N (or the node that the new access point will be added under). The temporary index can carry all the existing targets or access points 310 from the original indexed array as well as the new target (e.g., the new access point or the root of the created subtree).

At operation 622, the ticketing service 314 can start or initiate a ticket consumption timer responsive to creating the new array. The ticket consumption timer can correspond to an expiration time for the original array. The ticket consumption timer can be representative of the amount of time that the tickets from the original index array will expire, such that by the expiration time, the ticket can either be deleted or updated if the ticket is used or requested. The original array can be associated with a first time and the new array can be associated with a second time. Accordingly, the ticketing service 314 can reiterate the operations discussed above for adding one or more access points 310 to the data structure.

At operation 624, the ticketing service 314 can wait for a ticket operation request (e.g., adding, fetching, refreshing, deleting ticket request, etc.). At operation 626, the ticketing service 314 can determine whether the received ticket operation request is a ticket addition request. If the operation is a ticket add request (e.g., a ticket is generated or is an updated ticket), the ticketing service 314 can proceed to operation 630. For example, at operation 630, the ticketing service 314 can traverse the data structure using DestSelect rule to find owners for the ticket. The ticketing service 314 can use the operational index array (e.g., the new or temporary array), such that the tickets can be targeted to an owner access point based on the new list having the newly added access point. The DestSelect rule can be applied for any other ticket operation request.

At operation 628, if the request is not a ticket addition request, such as a ticket deletion, refresh, fetch, etc., the ticketing service 314 can use both the operational and original indexed arrays for owner identification. In this case, the ticketing service 314 can compare the creation (or updated) time of the ticket in the request to the time that the new array was created. If the ticket creation time is at or after the array creation time, the ticketing service 314 can use the new array for determining the owner access point, since the DestSelect rule can be based on the new array. Otherwise, if the ticket creation time is before the array creation time, the ticketing service 314 can use the original indexed array. In this case, the ticketing service 314 can update or refresh the ticket, such that the owner of the ticket can be targeted in the new array. When moving from the original to the operational array, the owner of the particular ticket may be the same or different based on the DestSelect rule, for example.

At operation 632, the ticketing service 314 can return or output an indication of the owner access point for the ticket. At operation 634, the ticketing service 314 can determine whether the ticket consumption timer has expired. If not, the ticketing service 314 can continue the process of receiving and processing the ticket operation requests (e.g., or one or more other ticketing services can perform the processing) until a predefined time offset until all the previous allocated tickets in the original array are consumed, updated, or expired.

At operation 636, subsequent to the time expiry, the ticketing service 314 can remove or delete the original array from node N, thereby allowing the operational indexed array to be used as the new indexed array for all subsequent ticket operations (e.g., until another access point is added). At operation 638, responsive to removing the original array, the ticketing service 314 can transition to “NORMAL” state where the ticketing service 314 can service further addition or deletion of access points. Accordingly, at operation 640, the process for adding the access point can conclude, and the ticketing service 314 can await further requests. Any updates to one data structure stored on an access point 310 can be reflected to other access points. In some case, the ticketing service 314 can obtain or receive the updated data structure from one or more other access points.

FIG. 7 illustrates an example flow diagram for deleting a POP. The operations of diagram 700 can be executed, performed, or otherwise carried out by one or more components of the system 300, including, for example, ticketing service 314 (e.g., map manager 318, ticket processor 320, etc.) (among other ticketing services), the computer 100, the cloud computing environment 214, or any other computing devices described herein in conjunction with FIGS. 1A-2C. Certain operations can be performed in any order or out of order based on the generation, setup, or arrangement of the data structure. One or more operations discussed herein can be similar to the operations of diagram 600.

At operation 702, the ticketing service 314 can receive a “DELETE” command to delete an access point from the data structure. In some cases, the ticketing service 314 can receive the “DELETE” command responsive to determining (e.g., by the map manager 318) that the ticket has expired due to, for example, a certain duration of inactivity (e.g., no client device 304 has requested access to a session using the ticket). In this case, the ticketing service 314 can be configured to automatically or dynamically remove or delete ticket(s) based on an expiration time. The expiration time can initiate when the ticket is generated and reset when the ticket has been updated, requested, among other actions associated with the ticket. The ticketing service 314 can perform the operations discussed herein dynamically for deleting an access node at runtime. At operation 704, the ticketing service 314 can determine whether the message (e.g., “DELETE” command) has been broadcasted. If not, the ticketing service 314 can proceed to operation 706 to broadcast the message. Otherwise, the ticketing service 314 can proceed to operation 708. Operations 704 and 706 can be similar to operations 604 and 606, for example.

At operation 708, the ticketing service 314 can transit to state “DELPROCESS” from state “NORMAL” where no further addition or deletion operations are allowed. At operation 710, similar to operation 610, the ticketing service 314 can traverse the data structure based on binding rule to find the leaf node N having the access point (Pn) to be deleted. At operation 712, the ticketing service 314 can determine whether the access node is a single target in node N (e.g., whether there is more than one access node or indices in the array associated with node N). At operation 718, if the leaf node N includes more than one target, the ticketing service 314 can delete the index associated with the access point Pn from the indexed array of N. In this case, the node N can continue to operate with the remaining access nodes.

At operation 714, if access point Pn is a single target in node N, the ticketing service 314 can find the subgroup or subtree (e.g., node N or the biggest subtree) hosting only the access point Pn without any other access point. The root R can represent the starting node of the this subtree. For instance, if the parent of node N hosts another subtree, node N can be the biggest subtree to be removed. In another example, if the parent of node N only includes node N, and the grandparent node includes another subtree, the ticketing service 314 can determine that the parent node is the biggest subtree to be removed. At operation 716, the ticketing service 314 can take the parent of root R as node N, such that the ticketing service 314 can remove the index associated with the subtree having only the access point Pn from the array of node N. For instance, in operation 718, the target (T) can be set as the index of access node Pn itself, while the operations 714 and 716, the target T can be set to the root node of the subtree being deleted and the Node N can be set to the parent of the root node.

To delete the target T from the indexed array of Node N, the ticketing service 314 can perform similar procedures as the addition operations (e.g., operation 620) to avoid incorrectly determining the owner after the deletion. For this purpose, at operation 720, the ticketing service 314 can create a temporary operational indexed array (e.g., new array) in node N carrying the existing indices from the original indexed array excluding the target T (e.g., the deleted index of the access point Pn). At this stage, the node N can point to two separate arrays, e.g., the original and new arrays.

Onward, including operations 722 to 740, the ticketing service 314 can perform similar procedures as operations 622 to 640. For example, at operation 722, the ticketing service 314 can start the ticket consumption timer. At operation 724, the ticketing service 314 can wait for the ticket operation request. At operation 726, the ticketing service 314 can determine whether the request is an add ticket request. If not, at operation 728, the ticketing service 314 can use both the original and new arrays to determine the owner access point based on the creation or updated time of the ticket. Otherwise, at operation 730, the ticketing service 314 can use the new array (e.g., operational indexed array) for owner selection. At operation 734, the ticketing service 314 can return an indication of the owner access point, such that the ticketing service 314 can either process the ticket or provide the ticket request to one or more owners, for example.

At operation 734, the ticketing service 314 can determine whether the ticket consumption timer has expired. If the timer has not expired, the ticketing service 314 can continue to wait for other ticket operation requests. Otherwise, at operation 736, the ticketing service 314 can delete the original array, thereby making the new array the next original array. At operation 738, the ticketing service 314 can transition to a state “NORMAL”, and at operation 740, the process for deleting the access point Pn and processing the ticket based on multiple arrays can conclude.

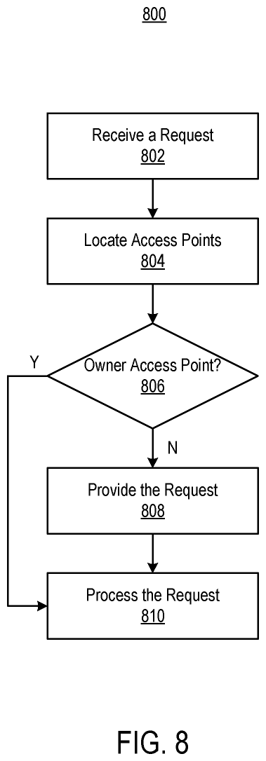

Referring to FIG. 8, depicted is an example flow diagram of a method 800 for end-point instance indexing and owner POP selection. The example method 800 can be executed, performed, or otherwise carried out by one or more components of the system 300 (e.g., access point 310, ticketing service 314 of the access point 310 (or other ticketing services), server 308, etc.), the computer 100, the cloud computing environment 214, or any other computing devices described herein in conjunction with FIGS. 1A-2C. The method 800 can include receiving a request, at step 802. At step 804, the method 800 can include locating access points (e.g., POPs, targets, etc.). At step 806, the method 800 can include determining whether the access point is an owner access point. At step 808, the method 800 can include providing the request. At step 810, the method 800 can include processing the request.

Still referring to FIG. 8 in further detail, at step 802, an access point (e.g., one or more processors, coupled to memory) can receive a request to process a ticket used to authenticate a connection to a session between a client device and one or more servers. The access point can include a ticketing service with one or more components to perform the steps discussed herein.

At step 804, the access point can locate various access points based on a function (e.g., the configuration including at least the binding rule and the DestSelect rule) applied to an identifier of the ticket (e.g., hashing and applying a modulus on the hased identifier). The access points can be distributed or divided across multiple groups of access points. Individual access points can store or maintain one or more tickets in the respective storage (e.g., to serve client device from the local storage). The access point can identify the multiple groups in an n-ary structure, among other types of data structure. Each of the groups ca include at least one access point.

The access point can obtain the function including at least the binding rule and the destination selection rule (e.g., DestSelect rule), for example, from the administrator of the access points or from other access points configured with the function. The binding rule can include one or more properties for assigning the access points to various groups (e.g., based on geographical location, local storage capacity, traffic handling capacity, associated cloud provider, etc.). The destination selection rule can indicate one or more owner access points that are assigned to the ticket.

At step 806, the access point can determine whether it is the owner access point (or if at least one other access point is the owner). If the access point is the owner, the access point can proceed to perform step 810. Otherwise, the access point can proceed to perform step 808. For instance, a first access point can receive the request to establish the connection to the session. The access point can determine that the first access point different from the access point is one of the owners of the ticket by traversing the data structure using the function. Accordingly, the access point can proceed to step 808. In some cases, the first access point can correspond to the access point, such that the access point is the owner. In this case, the access point can proceed to step 810, for example.

At step 808, if the access point is not the owner, the access point can provide the request to at least one of the owners determined based on the function. Once the owner (e.g., the first access point) receives the request, the owner access point can transmit or provide an update to one or more remaining owner access points indicating that the first access point is processing the request. Hence, other owners will not process the request, if the access point also provides the request to the other owners. If the access point is the owner, a similar procedure can be applied, such that the access point can provide an indication to the remaining owners indicating that the access point is processing the request.

At step 810, the access point (or another access point that is the owner of the ticket) can process the request. For example, the access point can provide the request to at least one access point located based on the function to perform the process on the ticket, or the access point can proceed directly to processing the ticket without providing the request to other owners.

The access point can process the request to determine whether the ticket (or the property of the ticket) is comparable or matches with the copy of the associated ticket stored on the local storage of the access point. If verified as a match, the access point can determine that the user is authorized. Otherwise, the access point may determine that the user is not authorized to establish a connection to the session.

In some cases, the access point can receive a response from another access point that is the owner of the ticket. The response can indicate whether the client device is authorized for the connection to the session. Accordingly, the access point can transmit or forward the response to the client device or the server. In this case, the access point can act as an intermediary between the owner and the external device. In some cases, the access point may indicate to the client device or the server to communicate directly to the owner access point to receive the response directly from the owner.

For example, subsequent to processing the ticket, the access point can determine one or more servers to host the session of an application for the client device based on the processed ticket. Based on the information indicated in the ticket, the access point can establish the connection to the session of an application hosted by the one or more servers. In another example, the access point can identify various cloud providers associated with the groups in the data structure. Hence, responsive to processing the ticket for authentication, the access point can establish the connection to the session hosted by the one or more servers of a cloud service associated with the at least one access point (e.g., the owner access point that processed the ticket) of at least one of the groups.

In various cases, the access point can receive a request to add an access point. The access point can determine, based on the function (e.g., binding rule or DestSelect rule) associated with one or more of the groups, one of the groups to add the access point. The group can include a first list (e.g., a first array) including indexes, each associated with a respective access point. The access point can determine a first timestamp associated with the request to add the access point. The access point can create or generate a second list for the same group including the various indexes and a new index of the access point. The access point can associate or include the first timestamp for the second list.

In this case, when the access point receives a request to process the ticket, if the group traversed using the function includes multiple arrays, the access point can compare a second timestamp associated with when the ticket is created to the first timestamp of the new array. Responsive to the comparison, the access point can determine to use the first list based on the second timestamp being earlier than the first timestamp or use the second list based on the second timestamp at or later than the first timestamp.

In further cases, responsive to the generation of the second list, the access point can determine an expiration of the first based on the duration of the first timestamp satisfying a threshold (e.g., expiration duration). Based on the determination, if the duration from the first timestamp exceeds the threshold, the access point can remove the first list (e.g., original array or list) from the group.

Similar to adding the access point, the access point can receive a request to delete an access point. One or more operations can be similar to the addition operation. For instance, the access point can determine, based on the function associated with various groups, one of the groups to delete the access point from. The access point can identify the access point to be deleted from the group and accordingly delete the index associated with this access point from the group or from the list of the group. In some cases, the access point can determine that the list of the group includes one index associated with the access point. In this case, the access point can delete the group from the list of groups, as there are no other access points with similar property to assign to this group.

### Further Example Embodiments

The following examples pertain to further embodiments, from which numerous permutations and configurations will be apparent.

Example 1 includes a method, comprising: receiving, by one or more processors coupled to memory, a request to process a ticket used to authenticate a connection to a session between a client device and one or more servers; locating, by the one or more processors based on a function applied to an identifier of the ticket, a plurality of access points across a plurality of groups of access points that each maintain the ticket in storage on the plurality of access points; and providing, by the one or more processors, the request to at least one access point of the plurality of access points located based on the function to perform the process on the ticket.

Example 2 includes the subject matter of Example 1, further comprising: receiving, by the one or more processors, a response from the at least one access point indicating whether the client device is authorized for the connection to the session; and transmitting, by the one or more processors, the response to the client device.

Example 3 includes the subject matter of any of Examples 1 and 2, further comprising: receiving, by the one or more processors, the request to process the ticket; determining, by the one or more processors, subsequent to processing the ticket, the one or more servers to host the session of an application for the client device based on the processed ticket; and establishing, by the one or more processors, the connection to the session of an application hosted by the one or more servers.

Example 4 includes the subject matter of any of Examples 1 through 3, wherein a first access point of the plurality of access points receives the request, the method further comprises: determining, by the one or more processors, that the first access point is an owner access point for the ticket; and providing, by the one or more processors, an update to one or more remaining owner access points indicating the first access point processing the request.

Example 5 includes the subject matter of any of Examples 1 through 4, further comprising obtaining, by the one or more processors, the function comprising at least a binding rule and a destination selection rule, the binding rule comprising one or more properties for assigning the plurality of access points to the plurality of groups, the destination selection rule indicating one or more owner access points of the plurality of access points assigned to the ticket.

Example 6 includes the subject matter of any of Examples 1 through 5, further comprising identifying, by the one or more processors, the plurality of groups in an n-ary structure, each of the plurality of groups comprising at least one of the plurality of access points.

Example 7 includes the subject matter of any of Examples 1 through 6, further comprising: identifying, by the one or more processors, a plurality of cloud services associated with the plurality of groups; and establishing, by the one or more processors, responsive to processing the ticket for authentication, the connection to the session hosted by the one or more servers of a cloud service associated with the at least one access point of at least one of the plurality of groups.

Example 8 includes the subject matter of any of Examples 1 through 7, further comprising: receiving, by the one or more processors, a request to add an access point; determining, by the one or more processors based on the function associated with one or more of the plurality of groups, a group of the plurality of groups to add the access point, the group comprising a first list comprising a plurality of indexes, each index associated with a respective access point; determining, by the one or more processors, a first timestamp associated with the request to add the access point; and generating, by the one or more processors, a second list for the group comprising the plurality of indexes and a new index of the access point, the second list associated with the first timestamp.

Example 9 includes the subject matter of any of Examples 1 through 8, further comprising: receiving, by the one or more processors, the request to process the ticket; determining, by the one or more processors based on the function applied to the identifier of the ticket, the group assigned to the ticket; comparing, by the one or more processors, a second timestamp associated with when the ticket is created to the first timestamp; and determining, by the one or more processors responsive to the comparison, to use the first list based on the second timestamp earlier than the first timestamp or use the second list based on the second timestamp at or later than the first timestamp.

Example 10 includes the subject matter of any of Examples 1 through 9, further comprising: determining, by the one or more processors responsive to generating the second list, an expiration of the first list based on a duration from the first timestamp satisfying a threshold; and removing, by the one or more processors, the first list responsive to determining the expiration

Example 11 includes the subject matter of any of Examples 1 through 10, further comprising: receiving, by the one or more processors, a request to delete an access point; determining, by the one or more processors based on the function associated with one or more of the plurality of groups, a group of the plurality of groups to delete the access point, the group comprising a list comprising one or more indexes, each index associated with a respective access point; and deleting, by the one or more processors based on the function, the index associated with the access point from the group.

Example 12 includes the subject matter of any of Examples 1 through 11, further comprising: determining, by the one or more processors, that the list of the group comprises one index associated with the access point; and deleting, by the one or more processors based on the determination, the group from the plurality of groups.

Example 13 includes a system, comprising: one or more processors coupled to memory, the one or more processors configured to: receive a request to process a ticket used to authenticate a connection to a session between a client device and one or more servers; locate, based on a function applied to an identifier of the ticket, a plurality of access points across a plurality of groups of access points that each maintain the ticket in storage on the plurality of access points; and provide the request to at least one access point of the plurality of access points to perform the process on the ticket.

Example 14 includes the subject matter of Example 13, wherein the one or more processors further configured to: receive a response from the at least one access point indicating whether the client device is authorized for the connection to the session; and transmit the response to the client device.

Example 15 includes the subject matter of any of Examples 13 and 14, wherein the one or more processors further configured to: receive the request to process the ticket; determine, subsequent to processing the ticket, the one or more servers to host the session of an application for the client device based on the processed ticket; and establish the connection to the session of an application hosted by the one or more servers.

Example 16 includes the subject matter of any of Examples 13 through 15, wherein a first access point of the plurality of access points receives the request, wherein the one or more processors further configured to: determine that the first access point is an owner access point for the ticket; and provide an update to one or more remaining owner access points indicating the first access point processing the request.

Example 17 includes the subject matter of any of Examples 13 through 16, wherein the one or more processors further configured to obtain the function comprising at least a binding rule and a destination selection rule, the binding rule comprising one or more properties for assigning the plurality of access points to the plurality of groups, the destination selection rule indicating one or more owner access points of the plurality of access points assigned to the ticket.

Example 18 includes the subject matter of any of Examples 13 through 17, wherein the one or more processors further configured to: identify a plurality of cloud services associated with the plurality of groups; and establish, responsive to processing the ticket for authentication, the connection to the session hosted by the one or more servers of a cloud service associated with the at least one access point of at least one of the plurality of groups.

Example 19 includes the subject matter of any of Examples 13 through 18, wherein the one or more processors further configured to identify the plurality of groups in an n-ary structure, each of the plurality of groups comprising at least one of the plurality of access points.

Example 20 includes a non-transitory computer readable storage medium storing instructions that, when executed by one or more processors, cause the one or more processors to: receive a request to process a ticket used to authenticate a connection to a session between a client device and one or more servers; locate, based on a function applied to an identifier of the ticket, a plurality of access points across a plurality of groups that each maintain the ticket in storage on the plurality of access points; and provide the request to at least one access point of the plurality of access points to perform the process on the ticket.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method, comprising:
receiving, by one or more processors coupled to memory, a request to process a ticket used to authenticate a connection to a session between a client device and one or more servers;
locating, by the one or more processors based on a function applied to an identifier of the ticket, a plurality of access points across a plurality of groups of access points that each maintain the ticket in storage on the plurality of access points; and
providing, by the one or more processors, the request to at least one access point of the plurality of access points located based on the function to perform the process on the ticket.

2. The method of claim 1, further comprising:
receiving, by the one or more processors, a response from the at least one access point indicating whether the client device is authorized for the connection to the session; and
transmitting, by the one or more processors, the response to the client device.

3. The method of claim 1, further comprising:
receiving, by the one or more processors, the request to process the ticket;
determining, by the one or more processors, subsequent to processing the ticket, the one or more servers to host the session of an application for the client device based on the processed ticket; and
establishing, by the one or more processors, the connection to the session of an application hosted by the one or more servers.

4. The method of claim 1, wherein a first access point of the plurality of access points receives the request, the method further comprises:
determining, by the one or more processors, that the first access point is an owner access point for the ticket; and
providing, by the one or more processors, an update to one or more remaining owner access points indicating the first access point processing the request.

5. The method of claim 1, further comprising obtaining, by the one or more processors, the function comprising at least a binding rule and a destination selection rule, the binding rule comprising one or more properties for assigning the plurality of access points to the plurality of groups, the destination selection rule indicating one or more owner access points of the plurality of access points assigned to the ticket.

6. The method of claim 1, further comprising identifying, by the one or more processors, the plurality of groups in an n-ary structure, each of the plurality of groups comprising at least one of the plurality of access points.

7. The method of claim 1, further comprising:
identifying, by the one or more processors, a plurality of cloud services associated with the plurality of groups; and
establishing, by the one or more processors, responsive to processing the ticket for authentication, the connection to the session hosted by the one or more servers of a cloud service associated with the at least one access point of at least one of the plurality of groups.

8. The method of claim 1, further comprising:
receiving, by the one or more processors, a request to add an access point;
determining, by the one or more processors based on the function associated with one or more of the plurality of groups, a group of the plurality of groups to add the access point, the group comprising a first list comprising a plurality of indexes, each index associated with a respective access point;
determining, by the one or more processors, a first timestamp associated with the request to add the access point; and
generating, by the one or more processors, a second list for the group comprising the plurality of indexes and a new index of the access point, the second list associated with the first timestamp.

9. The method of claim 8, further comprising:
receiving, by the one or more processors, the request to process the ticket;
determining, by the one or more processors based on the function applied to the identifier of the ticket, the group assigned to the ticket;
comparing, by the one or more processors, a second timestamp associated with when the ticket is created to the first timestamp; and
determining, by the one or more processors responsive to the comparison, to use the first list based on the second timestamp earlier than the first timestamp or use the second list based on the second timestamp at or later than the first timestamp.

10. The method of claim 8, further comprising:
determining, by the one or more processors responsive to generating the second list, an expiration of the first list based on a duration from the first timestamp satisfying a threshold; and
removing, by the one or more processors, the first list responsive to determining the expiration.

11. The method of claim 1, further comprising:
receiving, by the one or more processors, a request to delete an access point;
determining, by the one or more processors based on the function associated with one or more of the plurality of groups, a group of the plurality of groups to delete the access point, the group comprising a list comprising one or more indexes, each index associated with a respective access point; and
deleting, by the one or more processors based on the function, the index associated with the access point from the group.

12. The method of claim 11, further comprising:
determining, by the one or more processors, that the list of the group comprises one index associated with the access point; and
deleting, by the one or more processors based on the determination, the group from the plurality of groups.

13. A system, comprising:
one or more processors coupled to memory, the one or more processors configured to:
receive a request to process a ticket used to authenticate a connection to a session between a client device and one or more servers;
locate, based on a function applied to an identifier of the ticket, a plurality of access points across a plurality of groups of access points that each maintain the ticket in storage on the plurality of access points; and
provide the request to at least one access point of the plurality of access points to perform the process on the ticket.

14. The system of claim 13, wherein the one or more processors further configured to:
receive a response from the at least one access point indicating whether the client device is authorized for the connection to the session; and
transmit the response to the client device.

15. The system of claim 13, wherein the one or more processors further configured to:
receive the request to process the ticket;
determine, subsequent to processing the ticket, the one or more servers to host the session of an application for the client device based on the processed ticket; and
establish the connection to the session of an application hosted by the one or more servers.

16. The system of claim 13, wherein a first access point of the plurality of access points receives the request, wherein the one or more processors further configured to:
determine that the first access point is an owner access point for the ticket; and
provide an update to one or more remaining owner access points indicating the first access point processing the request.

17. The system of claim 13, wherein the one or more processors further configured to obtain the function comprising at least a binding rule and a destination selection rule, the binding rule comprising one or more properties for assigning the plurality of access points to the plurality of groups, the destination selection rule indicating one or more owner access points of the plurality of access points assigned to the ticket.

18. The system of claim 13, wherein the one or more processors further configured to identify the plurality of groups in an n-ary structure, each of the plurality of groups comprising at least one of the plurality of access points.

19. The system of claim 13, wherein the one or more processors further configured to:
identify a plurality of cloud services associated with the plurality of groups; and
establish, responsive to processing the ticket for authentication, the connection to the session hosted by the one or more servers of a cloud service associated with the at least one access point of at least one of the plurality of groups.

20. A non-transitory computer readable storage medium storing instructions that, when executed by one or more processors, cause the one or more processors to:
receive a request to process a ticket used to authenticate a connection to a session between a client device and one or more servers;
locate, based on a function applied to an identifier of the ticket, a plurality of access points across a plurality of groups that each maintain the ticket in storage on the plurality of access points; and
provide the request to at least one access point of the plurality of access points to perform the process on the ticket.
